(19) United States
(12) Patent Application Publication
(10) Pub. No.: US 2025/0220361 A1
(43) Pub. Date: Jul. 3, 2025

(54) AUDIO SOUND REPRODUCTION USING QUANTUM AUDIO TRANSDUCERS

(71) Applicant: MONOPHASE LLC, Armonk, NY (US)

(72) Inventors: James J. Fallon, Armonk, NY (US); Stephen J. Weiss, New Rochelle, NY (US)

(21) Appl. No.: 19/008,901

(22) Filed: Jan. 3, 2025

Related U.S. Application Data
(60) Provisional application No. 63/617,115, filed on Jan. 3, 2024.

(51) Int. Cl. H04R 23/00; H04R 1/10; H04R 1/40; H04R 3/12; H04R 5/033

(52) U.S. Cl. CPC H04R 23/00; H04R 1/1041; H04R 1/1075; H04R 1/403; H04R 3/12; H04R 5/033; H04R 2201/401; H04R 2430/01

(57) ABSTRACT

An apparatus comprises an audio transducer, and a control system. The audio transducer comprises a first electrically conductive element and a second electrically conductive element with an optional dielectric element disposed between them. The control system is configured to generate a voltage that is modulated in accordance with an audio signal, and apply the voltage to the audio transducer to cause an electric field to be generated between the first electrically conductive element and the second electrically conductive element, wherein the electric field causes acoustic sound pressure to be generated which reproduces sound corresponding to the audio signal. Arrays of the audio transducer may be configured to reside within earphones such as earbuds, on ear or over ear headsets, wherein the audio transducer arrays are configured to emulate a multi-speaker three-dimensional surround sound system.

### CROSS-REFERENCE TO RELATED APPLICATION

This application claims the benefit of and priority to U.S. Provisional Patent Application No. 63/617,115, filed on Jan. 3, 2024, the disclosure of which is fully incorporated herein by reference.

### TECHNICAL FIELD

The present disclosure relates generally to audio sound reproduction techniques and more particularly to novel architectural and operating paradigms of audio transducers.

### BACKGROUND

Originally invented for use in telephones in 1861 by Johann Philipp Reis, the audio speaker initially went through an extensive and rapid development until 1924 when Chester W. Rice of General Electric and Edward W. Kellogg of AT&T first patented moving coil technology using a permanent magnet and induction to move the coil and diaphragm to produce sound waves. Called an electrodynamic speaker, it is still by the far the most prevalent speaker in use today. While substantial progress has been made on electrodynamic speakers, they still suffer from a myriad of problems including poor efficiency, resonances due to moving mechanical parts, the need for large speaker sizes and enclosures to reproduce low audio frequencies, and extensive non-linearities with magnetic materials, magnetic voice coils, and their physical interactions, resulting in distortion and lack of fidelity of the reproduced audio signal.

Other existing technologies suffer from similar types of limitations. Traditional flat panel speakers utilizing electrodynamic technology such as a traditional voice coil and flat polystyrene surface diaphragm tradeoff decreased sound reproduction fidelity and distortion for smaller physical size. Planar speakers utilize a fixed magnetic structure with a voice coil etched or deposited on a flexible flat surface diaphragm such as plastic, typically mylar. The sound fidelity of this type of speaker s greatly improved over traditional flat panel speakers with substantially increased cost and lower efficiency. In addition, all types of flat panel and planar speakers are notoriously bad at reproducing low frequencies since their moving surfaces have very short travel regions.

Multicell flat diaphragm speakers utilize electrodynamic speaker technology with multiple voice coil cells wound around extruded surfaces in a flexible, typically mylar, sheet creating a flat diaphragm with multiple voice coils. Extended permanent magnets are utilized to create electrodynamic speaker cells. As each cell is a “portion” of a traditional electrodynamic speaker coil, the coils have a low impedance and require an impedance matching device such as a transformer which can limit sound reproduction fidelity. In addition, the distributed architecture of the speaker and magnet structure greatly increases weight over most other types of speaker technologies. As with all flat panel speakers, limited diaphragm travel restricts low frequency sound reproduction.

Electrostatic flat panel speakers typically employ two metal grids and flat plastic sheet such as mylar to act as a moving diaphragm. The sheet is coated with an electrically conductive material such as graphite. High voltage audio signals are superimposed on the two metal grids which cause the diaphragm to move. Electrostatic speakers offer at least an order of magnitude improvement in sound fidelity over electrodynamic and planar speakers since they have a large, highly uniform, ultra-low mass diaphragm. They suffer from extremely poor inefficiency, complex drive electronics, and limited low frequency response again because of the limited motion of the diaphragm.

Ribbon speakers are often referred to as line source transducers as they radiate sound form a planar surface, more akin to a line. A low mass electrically conductive foil film is used as a diaphragm. The thin strip of foil film on a plastic, such as mylar, is suspended between two bar magnets. The low mass allows for excellent fidelity and ultra-fast transient response. Ribbon speakers are highly inefficient, their inherently low impedance requires an impedance matching device such as a transformer which can degrade audio fidelity. In addition, the radiated sound field varies dramatically with frequency and only radiates in one dimension at very high frequencies. Finally ribbon speakers suffer from resonant frequencies which limits their useful design frequency range.

Piezoelectric speakers utilize the piezoelectric effect found in certain types of crystals where an applied electric voltage induces a mechanical expansion. The process is reversible allowing for high frequency expansion and contraction. The piezoelectric crystal is coupled to a diaphragm and varying the applied voltage in response to an electrical audio signal vibrates the air to produce sound. Piezoelectric speakers are typically limited in frequency response to high frequencies and, therefore they are only used as tweeters or in small electrical devices like watches/clocks to make simple sounds. Stacked layers piezo crystals are being developed to allow for greater mechanical travel that should result in a more useable audio transducer. Piezo stacks require much high drive voltages and suffer from certain types of non-linearities.

Ion and plasma speakers utilize two or more electrodes, in conjunction with one or more high voltage sources, along with an audio modulation circuit. To generate the initial polarizing voltage for a Glow or Arc discharge, direct or alternate current sources can be used. In most cases, the electrodes sustaining the plasma discharge are symmetrical, and thus is the discharge. The audio signal must be modulated and fed into the system to produce the corresponding waveform. This can be achieved through different means including, e.g., pulse width modulation (PWM), frequency modulation (FM), or transverse magnetic field. In addition, an ionized field can be setup and additional grids or plates utilized to with an applied audio modulated voltage field. To date very few ion or plasma speakers have been built. They are very extremely expense, generate toxic levels of ozone, are large, often utilize very big transformers, possess limited low frequency range if any, and offer extremely poor efficiency.

Prior art speaker technologies are not well suited for implementing surround sound within earbuds and headsets. With the advent of Dolby ATMOS and other cutting-edge surround sound technologies that create three-dimensional sound fields, allowing sounds to be perceived as coming from all directions, including overhead, current art earbuds and headsets are extremely limited in their ability to accurately recreate the 3D sound field. Earbuds, with their requirement to fit snuggly within the inner and/or outer ear canal, have limited space to place multiple audio transducers and modern earbuds often utilize a single speaker diaphragm of approximately 12 millimeters to 15 millimeters, with canalphones closer to a range of 8 millimeters to 13 millimeters. On car and over ear headsets often have a speaker diaphragm of approximately 25 millimeters to 60 millimeters. Binaural rendering is typically used to simulate the experience of having multiple speakers spatially arranged, however this virtualization with a single audio transducer in each car has many performance limitations and cannot accurately simulate height or a true 3D spatial audio.

In short, all existing audio speaker technologies suffer from a combination of limitations including large speaker size and commensurately large enclosures for low frequency audio response, poor efficiency, heat generation from energy not converted in acoustic energy, lack of fidelity due to mechanical resonances or limited frequency range, speaker coil and magnetic inherent or mechanical non-linearities, various mechanical or ionic wear life limiting mechanisms, limited or difficult to control sound fields, and exponentially higher costs for improved acoustic fidelity.

These and other limitations of the above-mentioned sound reproduction techniques are solved by exemplary embodiments of the present disclosure as discussed herein. It should be noted that no disclosure in this background section is an admission of prior art.

### SUMMARY

Exemplary embodiments of the disclosure include audio sound reproduction apparatus and methods which are implemented using quantum effect audio transducers that are configured to generate in-atmosphere acoustic sound waves using an electric field to, e.g., liberate electrons from one or more electrically conductive surfaces and to excite and accelerate the liberated electrons to collide or otherwise interact with air or other gas molecules to generate to generate acoustic sound pressure, and thereby reproduce an audio input signal.

An exemplary embodiment includes an apparatus which comprises an audio transducer, and a control system. The audio transducer comprises a first electrically conductive element, a second electrically conductive element, and a dielectric element disposed between the first electrically conductive element and the second electrically conductive element. The control system is configured to generate a voltage that is modulated in accordance with an audio signal, and apply the voltage to the audio transducer to cause an electric field to be generated between the first electrically conductive element and the second electrically conductive element, wherein the electric field causes acoustic sound pressure to be generated which reproduces sound corresponding to the audio signal

Another exemplary embodiment includes an apparatus which comprises a pair of earphones including a left earphone and right earphone, and a control system configured to operate the pair of headphones. The left earphone comprises a first array of audio transducer cells, and the right earphone comprising a second array of audio transducer cells. The audio transducer cells of the first array and second array of audio transducer cells each comprise a first electrically conductive element, a second electrically conductive element, and a dielectric element disposed between the first electrically conductive element and the second electrically conductive element. The control system is configured to receive or acquire an audio signal, decode the audio signal into separate audio channels for driving the respective audio transducer cells of the first array and second array of audio transducer cells, generate voltages that are modulated in accordance with the separate audio channels, and apply the voltages to respective first and second electrically conductive elements of the audio transducer cells of the first array and second array of audio transducers cells to reproduce three-dimensional sound based on the audio signal.

Another exemplary embodiment includes an apparatus which comprises an audio transducer, and a control system. The audio transducer comprises a first electrically conductive element, and a second electrically conductive element disposed adjacent to each other. The control system is configured to generate a voltage that is modulated in accordance with an audio signal, and apply the voltage to the audio transducer to cause an electric field to be generated between the first electrically conductive element and the second electrically conductive element, wherein the electric field causes acoustic sound pressure to be generated which reproduces sound corresponding to the audio signal.

These and other exemplary embodiments of the disclosure will be described in the following detailed description of embodiments, which is to be read in conjunction with the accompanying figures.

### BRIEF DESCRIPTION OF THE DRAWINGS

FIGS. 1A, and 1B schematically illustrate an audio sound reproduction apparatus, according to an exemplary embodiment of the disclosure.

FIG. 1C schematically illustrates an audio sound reproduction apparatus, according to another exemplary embodiment of the disclosure.

FIGS. 1D and 1E schematically illustrate an audio sound reproduction apparatus, according to another exemplary embodiment of the disclosure.

FIG. 2 schematically illustrates an audio sound reproduction apparatus, according to another exemplary embodiment of the disclosure.

FIG. 3 schematically illustrates an audio sound reproduction apparatus, according to another exemplary embodiment of the disclosure.

FIG. 4 schematically illustrates an audio sound reproduction apparatus, according to another exemplary embodiment of the disclosure.

FIGS. 5A and 5B schematically illustrate an audio sound reproduction apparatus, according to another exemplary embodiment of the disclosure.

FIGS. 6A, 6B, and 6C schematically illustrate an audio sound reproduction apparatus, according to an exemplary embodiment of the disclosure.

FIG. 7 schematically illustrates an audio sound reproduction apparatus, according to an exemplary embodiment of the disclosure.

FIG. 8 schematically illustrates an audio sound reproduction apparatus, according to an exemplary embodiment of the disclosure.

FIGS. 9A and 9B schematically illustrate an audio sound reproduction apparatus, according to an exemplary embodiment of the disclosure.

FIGS. 10A and 10B schematically illustrate an audio sound reproduction apparatus which comprises earphones, according to an exemplary embodiment of the disclosure.

FIGS. 11A and 11B schematically illustrate an audio sound reproduction apparatus which comprises earphones, according to another exemplary embodiment of the disclosure.

FIG. 12 schematically illustrates an audio sound reproduction apparatus which comprises earphones, according to another exemplary embodiment of the disclosure.

### DETAILED DESCRIPTION OF EXEMPLARY EMBODIMENTS

Embodiments of the disclosure will now be described in further detail with regard to audio sound reproduction apparatus and methods which implement quantum effect audio transducers that are configured to generate in-atmosphere acoustic sound waves using an electric field to, e.g., liberate electrons from one or more electrically conductive surfaces and to excite and accelerate the liberated electrons to collide or otherwise interact with air or other gas molecules to generate to generate acoustic sound pressure, and thereby reproduce an audio input signal.

For example, an exemplary embodiment includes an apparatus which comprises an audio transducer, and a control system. The audio transducer comprises a first electrically conductive element, a second electrically conductive element, and a dielectric element disposed between the first electrically conductive element and the second electrically conductive element. The control system is configured to (i) generate a voltage that is modulated in accordance with an audio signal, and (ii) apply the voltage to the audio transducer to cause an electric field to be generated between the first electrically conductive element and the second electrically conductive element, wherein the electric field causes acoustic sound pressure to be generated which reproduces sound corresponding to the audio signal

In another exemplary embodiment, which may be combined with one or more of the embodiments of the preceding paragraphs, the dielectric element comprises a polyimide film.

In another exemplary embodiment, which may be combined with one or more of the embodiments of the preceding paragraphs, at least one of the first electrically conductive element and the second electrically conductive element comprises an electrically conductive grid.

In another exemplary embodiment, which may be combined with one or more of the embodiments of the preceding paragraphs, the electrically conductive grid comprises a copper mesh.

In another exemplary embodiment, which may be combined with one or more of the embodiments of the preceding paragraphs, at least one of the first electrically conductive element and the second electrically conductive element comprises at least one curve-shaped structure that partially contacts a surface of the dielectric element.

In another exemplary embodiment, which may be combined with one or more of the embodiments of the preceding paragraphs, the dielectric element is perforated.

In another exemplary embodiment, which may be combined with one or more of the embodiments of the preceding paragraphs, the first electrically conductive element and the second electrically conductive element are spaced apart from respective first and second surfaces of the dielectric element.

In another exemplary embodiment, which may be combined with one or more of the embodiments of the preceding paragraphs, at least one of the first electrically conductive element and the second electrically conductive element comprises a magnetic material.

In another exemplary embodiment, which may be combined with one or more of the embodiments of the preceding paragraphs, at least one of the first electrically conductive element and the second electrically conductive element comprises a metallic material.

In another exemplary embodiment, which may be combined with one or more of the embodiments of the preceding paragraphs, at least one of the first electrically conductive element and the second electrically conductive element comprises a perforated conductive sheet.

In another exemplary embodiment, which may be combined with one or more of the embodiments of the preceding paragraphs, the first electrically conductive element and the second electrically conductive element each comprise a planar element.

In another exemplary embodiment, which may be combined with one or more of the embodiments of the preceding paragraphs, the first electrically conductive element and the second electrically conductive element each comprise a curved element.

In another exemplary embodiment, which may be combined with one or more of the embodiments of the preceding paragraphs, the first electrically conductive element and the second electrically conductive element comprise concentric geometric shapes.

In another exemplary embodiment, which may be combined with one or more of the embodiments of the preceding paragraphs, the concentric geometric shapes comprise one of concentric circular shapes, concentric hexagonal shapes, and concentric cylindrical shapes.

In another exemplary embodiment, which may be combined with one or more of the embodiments of the preceding paragraphs, the control system is configured to increase a voltage range of the voltage that is applied to the audio transducer to increase a peak sound pressure level.

In another exemplary embodiment, which may be combined with one or more of the embodiments of the preceding paragraphs, the control system is configured to increase a voltage range of the voltage that is applied to the audio transducer to increase a root mean square sound pressure level.

Another exemplary embodiment includes an apparatus which comprises a pair of earphones including a left earphone and right earphone, and a control system configured to operate the pair of headphones. The left earphone comprises a first array of audio transducer cells, and the right earphone comprising a second array of audio transducer cells. The audio transducer cells of the first array and second array of audio transducer cells each comprise a first electrically conductive element, a second electrically conductive element, and a dielectric element disposed between the first electrically conductive element and the second electrically conductive element. The control system is configured to receive or acquire an audio signal, decode the audio signal into separate audio channels for driving the respective audio transducer cells of the first array and second array of audio transducer cells, generate voltages that are modulated in accordance with the separate audio channels, and apply the voltages to respective first and second electrically conductive elements of the audio transducer cells of the first array and second array of audio transducers cells to reproduce three-dimensional sound based on the audio signal.

In another exemplary embodiment, which may be combined with one or more of the embodiments of the preceding paragraphs, the first and second electrically conductive elements of the audio transducer cells comprise electrically conductive grids.

In another exemplary embodiment, which may be combined with one or more of the embodiments of the preceding paragraphs, the three-dimensional sound emulates a multi-speaker surround sound system.

In another exemplary embodiment, which may be combined with one or more of the embodiments of the preceding paragraphs, the pair of earphones comprises one of earbuds, canalphones, and headphones.

In another exemplary embodiment, which may be combined with one or more of the embodiments of the preceding paragraphs, the first array of audio transducer cells and the second array of audio transducer cells have mirror image structural layouts.

In another exemplary embodiment, which may be combined with one or more of the embodiments of the preceding paragraphs, the first array of audio transducer cells and the second array of audio transducer cells each comprise a rectangular array of audio transducer cells.

In another exemplary embodiment, which may be combined with one or more of the embodiments of the preceding paragraphs, the first array of audio transducer cells and the second array of audio transducer cells each comprise a circular and radial array of audio transducer cells.

In another exemplary embodiment, which may be combined with one or more of the embodiments of the preceding paragraphs, the first array of audio transducer cells and the second array of audio transducer cells each comprise a rectangular array of audio transducer cells with different footprint area sizes of audio transducer cells within the arrays.

Another exemplary embodiment includes an apparatus which comprises an audio transducer, and a control system. The audio transducer comprises a first electrically conductive element, and a second electrically conductive element disposed adjacent to each other. The control system is configured to generate a voltage that is modulated in accordance with an audio signal, and apply the voltage to the audio transducer to cause an electric field to be generated between the first electrically conductive element and the second electrically conductive element, wherein the electric field causes acoustic sound pressure to be generated which reproduces sound corresponding to the audio signal.

It is to be understood that the various layers, structures, and regions shown in the accompanying drawings are schematic illustrations that are not drawn to scale. In addition, the same or similar reference numbers are used throughout the drawings to denote the same or similar features, elements, or structures, and thus, a detailed explanation of the same or similar features, elements, or structures will not be repeated for each of the drawings. It is to be further understood that the term “about” as used herein with regard to thicknesses, widths, lengths, etc., is meant to denote being close or approximate to, but not exactly. The term “exemplary” as used herein means “serving as an example, instance, or illustration”. Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, firmware, and/or combinations thereof, and in implementations that comprise hardware, wherein the hardware may comprise discrete circuit elements (e.g., transistors, inverters, etc.), programmable elements (e.g., application specific integrated circuit (ASIC) chips, field-programmable gate array (FPGA) chips, etc.), processing devices (e.g., central processing units (CPUs), graphics processing units (GPUs), etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

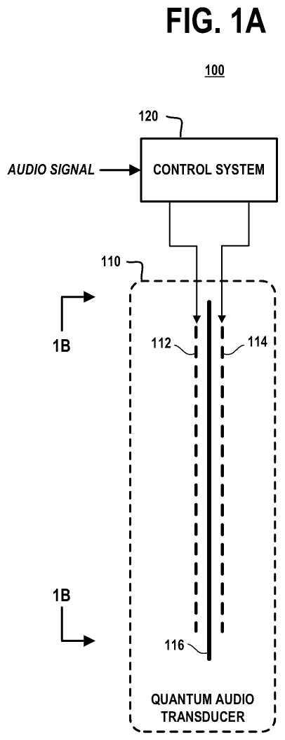

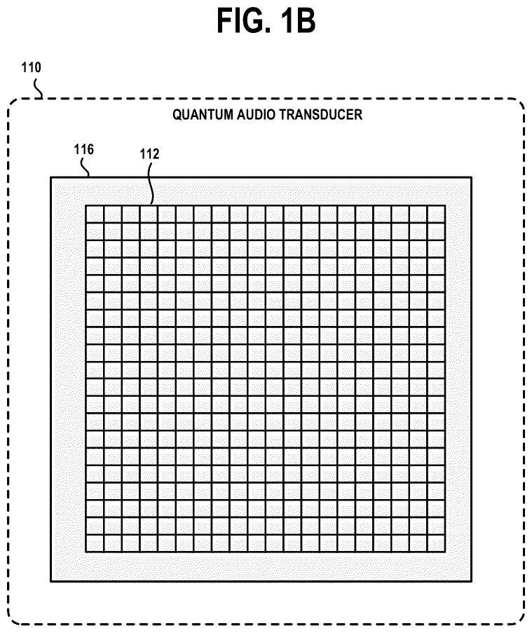

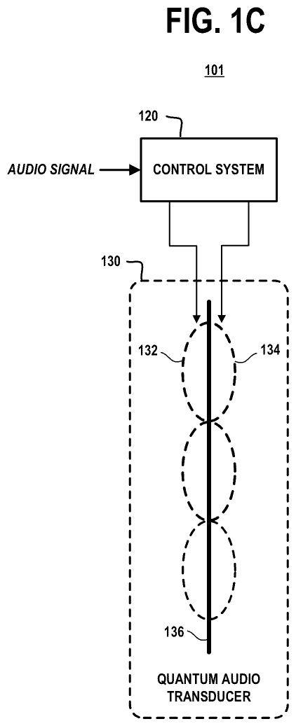

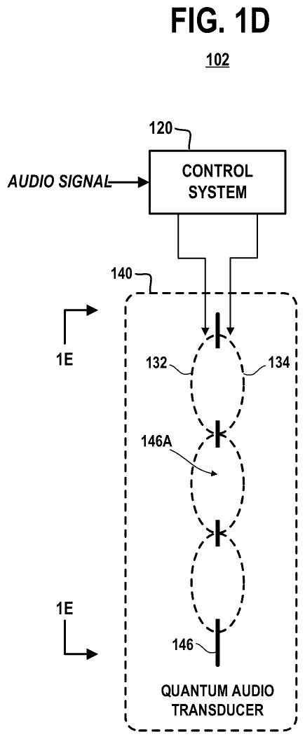

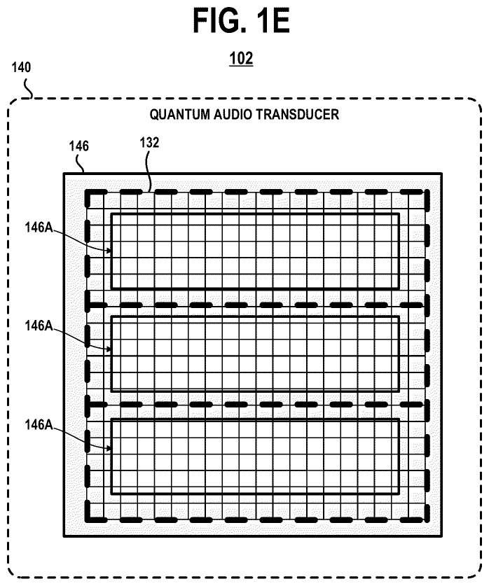

FIGS. 1A, 1B, 1C, 1D, 1E, 2, 3, 4, 5A, 5B, 6A, 6B, 6C, 7, 8, 9A, 9B, 10A, 10B, 11A, 11B, and 12 schematically illustrate various exemplary embodiments of audio sound reproduction apparatus and methods that implement novel architectural and operating paradigms of audio transducers which comprise quantum effect audio transducers that are configured to generate in-atmosphere acoustic sound waves using an electric field to, e.g., liberate electrons from one or more electrical conductive surfaces and to excite and accelerate the liberated electrons to collide or otherwise interact with air or other gas molecules to generate to generate acoustic sound pressure, and thereby reproduce an audio input signal. In general, exemplary embodiments of the disclosure include audio sound reproduction apparatus which comprise an audio transducer and control system. The audio transducer comprises a first electrically conductive element and a second electrically conductive element disposed adjacent to each other. The control system is configured to (i) generate a voltage that is modulated in accordance with an audio signal, and (ii) apply the voltage (or modulated voltage) to the audio transducer to cause an electric field to be generated between the first electrically conductive element and the second electrically conductive element, wherein the electric field liberates and accelerates electrons to collide or otherwise interact with air or other gas molecules to which causes acoustic sound pressure to be generated which reproduces sound corresponding to the audio signal.

The inventors hypothesize that a primary operating mechanism for the exemplary quantum audio transducers as disclosed herein is based on the phenomenon of electric field emission which the electric field that is generated as a result of applying the modulated voltage to the first and second electrically conductive elements causes the emission of electrons (or liberation of electrons) from one or both of the first electrically conductive element and the second electrical conductive element of the audio transducer. The liberated electrons are excited and accelerated by the electric field and collide with air molecules to generate acoustic sound pressure, and thereby reproduce sound which corresponds to the audio input signal. The field-induced emission of electrons from one or both of the first and second electrically conductive elements (e.g., metal/metallic elements) is a function of the magnitude of the applied electrical field (given in volts per meter) and a work function of the first and second electrically conductive elements.

In addition, the inventors hypothesize that a secondary operating mechanism for the exemplary quantum audio transducers as disclosed herein is based on at least a partial polarization of air due to a strong electric field generated between the first and second electrically conductive elements of the audio transducer. Indeed, when an electric field in air is strong enough, the electric field can ionize the air, e.g., cause the surrounding air to become separated into positive ions and electrons. The ionized air particles are excited and accelerated by the electric field and collide with air molecules to generate acoustic sound pressure, and thereby reproduce sound which corresponds to the audio input signal.

The exemplary quantum audio transducers as disclosed herein are configured to utilize relative low operating voltages to generate strong electric fields between the first and second electrically conductive elements of the audio transducer to cause the emission of electrons and other particles, while preventing the generation of ozone. In particular, the exemplary quantum audio transducers described herein are configured to operate in manner that does not produce ozone as a result of the strong electric field utilized to cause the field-induced emission of electrons from the electrically conductive elements of the audio transducers. Ozone, sometimes referred to as trioxygen, is an inorganic molecule with the chemical formula O₃. Ozone is created when a monatomic oxygen atom (O) combines with a single diatomic oxygen molecule (O₂) to form an ozone molecule (O₃). Ozone is a pale blue gas with a distinctively pungent smell. It is highly reactive with strong oxidizing properties. Ozone gas is hazardous to living organisms, with damage to mucous and respiratory tissues in animals and plants at concentrations of about 0.1 parts per million (ppm). By way of comparison, Chlorine gas requires approximately 60 parts per million to be an equivalent hazard, a concentration factor of 600 times higher. To prevent the production of ozone in a quantum audio transducer, the operating voltage for driving the quantum audio transducer is at a low enough level to generate an electric field to, e.g., liberate electrons from the electrically conductive elements of the quantum audio transducer, while preventing a breakdown of diatomic oxygen molecules (O₂) into two separate monoatomic oxygen molecules (2 O). Experimental working prototypes of quantum audio transducers have shown to reproduce sound as described herein, while not creating ozone as a result of operation of the quantum audio transducer.

Before discussing exemplary embodiments of audio sound reproduction apparatus as shown in FIGS. 1A, 1B, 1C, 1D, 1E, 2, 3, 4, 5A, 5B, 6A, 6B, 6C, 7, 8, 9A, 9B, 10A, 10B, 11A, 11B, and 12, a brief explanation will now be provided regarding the physics and theories associated with the characteristics and operations of quantum-effect audio transducers as disclosed herein. To begin, as noted above, the field-induced emission of electrons from an electrically conductive element (e.g., metal/metallic element) is based at least in part on a work function of the electrically conductive element. Work function is the minimum energy, sometimes referred to as thermodynamic work, required to free an electron from a surface and place it immediately outside the electrically conductive metal surface inside a vacuum. Immediately means that the freed electron position is far from the surface on the atomic scale, but still too close to the solid to be influenced by ambient electric fields in the vacuum. The work function is not solely a characteristic of a bulk material, but rather includes properties of the surface of the material (depending on crystal face, contamination, and sometimes other properties).

In some embodiments, as noted above, the field-induced emission of electrons from an electrically conductive element of a quantum audio transducer results in the liberation of a sufficient number of electrons which are then accelerated by the electric field to collide or otherwise interact with air or other gas molecules to create a sound pressure level for the intended audio application. By way of example, a headset or earbud will need far fewer liberated electrons collide or otherwise interact with air or other gas molecules to as compared with a large sound reinforcement system given the same external electrical field.

Calculating the kinetic energy of emitted electrons and their subsequent interaction with air molecules allows us to understand and quantify the sound pressure levels generated by a quantum audio transducer. In general, the energy E_{f} <eV> of an electron freed (liberated) from an electrically conductive element of a quantum audio transducer is based at least on a work function W of the electrically conductive element. An electron volt <eV> is defined as the unit of energy equal to the work done on an electron in accelerating it through a potential difference of one volt, wherein 1 <eV>=1.602×10⁻¹⁹ <Joules>.

Moreover, the additional kinetic energy imparted to freed electrons will depend on the externally applied electric (voltage) field between the first and second electrically conductive elements of the quantum audio transducer. The additional electron energy is linearly proportional to an externally applied electoral (voltage) field. The mass of an electron is defined to be approximately: Mₑ=Mass of an electron=9.1093877×10⁻³¹ <kilograms>.

Assume that KEₑ denotes the kinetic energy of an election <joules>, the kinetic energy of an electron may be computed as:

KEₑ=qV <joules> EQ[1], where:
q=Electron Charge <coulombs>=1.60217663×10⁻¹⁹ <coulombs>, and
V=Voltage of Externally Applied Field <volts>.

We also know that kinetic energy is governed by the following relationship:

KEₑ=½Mₑ×vₑ² <joules> EQ[2], where:
vₑ=electron velocity <meters/second>.

Setting Equations 1 and 2 equal to each other yields:

### EQ[3]:

$$K {E}_{e} = qV < joules >= 1 / 2 {M}_{e} \times {v}_{e}^{2} < joules >$$

The additional velocity vₑ imparted to a freed electron from an external voltage field can
be determined by rearranging Equation 3 to solve for electron velocity as follows:

### EQ[4]:

$${v}_{e} = \sqrt{2 qV / {M}_{e}} .$$

In some embodiments, an exemplary quantum audio transducer generates acoustic sound waves by creating and modulating one or more of either the quantity of free electrons generated, the kinetic energy of the free electrons generated, or the additional kinetic energy imparted to the free electrons. The freed and accelerated electrons collide with air molecules to create sound waves.

Sound level is typically defined in terms of sound pressure level (SPL). SPL is a logarithmic measure of the effective sound pressure of a sound relative to a reference value. It is measured in decibels (dB) above a standard reference level. The standard reference sound pressure in air or other gases is 20 μPa, which is usually considered the threshold of human hearing (at 1 kHz). Sound pressure (ρ) is a local pressure deviation from the ambient (average, or equilibrium) atmospheric pressure, caused by a sound wave. In air, sound pressure can be measured using a microphone. The SI unit for sound pressure (ρ) is the pascal (symbol: Pa), which equates to 1 Newton per Meter squared (1 N/m²).

Propagating sound waves in air or a gas induce localized deviations called dynamic pressure in the ambient air or gas referred to as static pressure. If we define the total pressure as ρtotal, the static pressure as ρstatic, and the sound pressure as ρ, then we have the following relationship:

### EQ[5]:

$$ρ total = ρ static + ρ$$

If we define Lρ as SPL, the logarithmic measure of the effective pressure of sound relative to a reference value, ρ₀ as our reference sound pressure which we will set as 20 μPa (ANSI S1.1-1994 reference level), and p as the root mean square sound pressure, Nρ as 1 neper, B as 1 bel which equates to (½ ln 10)Nρ, and 1 dB which equates to ( 1/20 ln 10) Nρ, then:

### EQ[6]:

$$Lp = ln ( \frac{ρ}{ρ0} ) N ρ = 2 {log}_{10} ( \frac{ρ}{ρ0} ) B = 20 {log}_{10} ( \frac{ρ}{ρ0} ) dB .$$

With a lower limit of audibility defined as SPL of 0 dB, and the upper limit in 1 atmosphere of pressure (approximately 1.01325×10⁵ Pa) or 191 dB SPL (the largest pressure variation an undistorted sound wave can have in Earth's atmosphere).

SPL is also often governed by an inverse-proportional law. SPL is measured from the origin of an acoustic event or source, and the sound pressure from a spherical sound wave decreases proportionally to the reciprocal of the distance. The human car has an extremely large dynamic range. In standard atmospheric pressure, a leaf rustling as ambient sound may create a sound pressure of approximately 6.32×10⁻⁵ Pa which equates to an SPL of approximately 10 dB. Typical human conversation at a distance of 1 meter ranges from about 2×10⁻³ Pa to about 20×10⁻² Pa, which equates to an SPL of about 40 dB to about 60 dB. A passenger car as heard from roadside at a distance of 10 meters ranges from approximately about 2×10⁻² to about 20×10⁻² Pa which equates to approximately 60 dB to 80 dB. Traffic on a busy roadway at 10 meters is about 0.2 Pa to about 0.632 Pa, which is approximately 80 dB to 90 dB of SPL. An example of a higher SPL is an operating jack hammer at 1 meter, which is approximately 2 Pa or approximately 100 dB SPL. The sound pressure generated by a jet engine at a distance of 100 meters can range from 6.32 Pa to 200 Pa which is approximately equivalent to 110 dB to 140 dB SPL. Moving closer to a jet engine, e.g., 1 meter, increases the sound pressure to a level of about 632 Pa or approximately 150 dB SPL. The threshold of pain for humans is about 63.2 Pa to 200 Pa or about 130 dB to 140 dB. Examples of even higher sound pressure levels include those generated by a 30-06 rifle, at a distance of 1 meter, which is approximately 7,265 Pa which or 171 dB SPL. Finally, the theoretical limit for undistorted sound is approximately 101,325 Pa or approximately 191 dB.

As noted above, SPL is a logarithmic measure of the effective sound pressure of a sound relative to a reference value. It is measured in decibels (dB) above a standard reference level of 20 μPa. A high voltage field of 20 kilovolts with a current of 100 microamperes will generate a sound pressure level of 45 pascals. Referring back to Equation 6, by setting p=45 pascals, and by definition: p₀=20 micro pascals, the acoustic output will be:

$$S P L = 20 {log}_{10} ( \frac{ρ}{ρ0} ) dB = 20 {log}_{10} ( \frac{45}{20 \times {10}^{- 6}} ) = 127.0 \; 44 dB .$$

An externally applied voltage of 20 kilovolts to a single electron yields a total kinetic energy governed by Equation 1 above: KEₑ=qV <joules>, where q denotes electron charge (in coulombs)=1.60217663×10⁻¹⁹ <coulombs>, and V denotes the voltage (volts) of the externally applied electric field. Thus, for each electron in a 20 kilovolt electric field, the kinetic energy is:

$$K {E}_{e} < joules >= 1.60 \; 217663 \times {10}^{- 19} < coulombs > \times 20 \times {10}^{3} < volts > .$$

Previously we stated that 1 ampere=1 coulomb/second, where 1 coulomb=6.241×10¹⁸ <electrons> and:
Ψₑ=Electron Flux emitted from Electrically Conductive Surface <electrons/second> and
Iₑ=Electrical Current emitted from Electrically Conductive Surface <amperes>.

In order to calculate the total kinetic energy required to create a 45 pascal sound wave, we multiply the number of electrons times the kinetic energy for each electron as follows:

KEₜₒₜₐₗ(45 pascals)=Σ_{total number of electrons}Ψₑ×KEₑ EQ[7], which yields:
KEₜₒₜₐₗ(45 pascals)=6.241×10¹⁴×3.20435×10⁻¹⁵ <joules>=1.99983 <joules>.

The exemplary quantum audio transducers as disclosed herein are configured to operate at operating voltages (e.g., 1000 V) that enable the creation of high electric fields for producing sound, but with low power (e.g., 2 W). For example, as explained in further detail below, the field-induced emission of electrons from an electrically conductive element of a quantum audio transducer is achieved by spacing two electrically conductive elements of a quantum audio transducer apart by a small distance (e.g., order of millimeters or microns), to create high electric fields between the two electrically conductive elements, e.g., the electric field strength E between the two electrically conductive elements is directly proportional to the voltage V applied across the two electrical conductive elements, and inversely proportional to the distance d between the two electrical conductive elements. i.e.,

$$E = \frac{V}{d} .$$

The strength of the electric field E is sufficient to result in the liberation of a sufficient number of electrons which are then accelerated by the electric field to create a sound pressure level for the intended audio application, without producing Ozone.

FIGS. 1A and 1B schematically illustrate an audio sound reproduction apparatus, according to an exemplary embodiment of the disclosure. More specifically, FIGS. 1A and 1B schematically illustrate an audio sound reproduction apparatus 100 which comprises a quantum audio transducer 110 and a control system 120. As schematically shown in FIG. 1A, the quantum audio transducer 110 comprises a first electrically conductive grid 112 (alternatively, first electrical grid 112), a second electrically conductive grid 114 (alternatively, second electrical grid 114), and a dielectric element 116 (alternatively, dielectric sheet 116) disposed between the first and second electrically conductive grids 112 and 114. The control system 120 is electrically coupled to both of the first and second electrically conductive grids 112 and 114. FIG. 1B is a schematic plan view of one side of the quantum audio transducer 110 along line 1B-1B in FIG. 1A, wherein the dielectric element 116 and the first electrically conductive grid 112 are shown to be rectangular-shaped elements.

The control system 120 is configured to control the operation of the quantum audio transducer 110. In some embodiments, the control system 120 receives an input audio signal, and generates an output voltage which applied to the first and second electrical grids 112 and 114, which results in transducing the input audio signal into acoustic sound waves. More specifically, in some embodiments, the control system 120 is configured to (i) generate a voltage that is modulated in accordance with the input audio signal, and (ii) apply the voltage to the audio transducer 110 to cause an electric field to be generated between the first and second electrical grids 112 and 114, wherein the electric field causes acoustic sound pressure to be generated which reproduces sound corresponding to the audio signal. The control system 120 comprises a voltage source (or in some embodiments a current source) that is modulated by the input audio signal to generate an output voltage which comprises a modulated voltage signal (e.g., amplified AC audio signal) that is applied to the first and second electrical grids 112 and 114. The output voltage generates a modulated electric field between the first and second electrical grids 112 and 114, which results in the generating of acoustic sound waves.

The magnitude of the modulated electric field between the first and second electrical grids 112 and 114 is proportional to the amplitude of the modulated output voltage and, thus, proportional to a sound pressure output of the audio sound reproduction apparatus 100. In such embodiments, the voltage range of the applied electric field is utilized to set the peak or root mean square sound pressure output. The voltage range of the applied external field may be increased to increase the peak sound pressure level, root mean square sound pressure level, or system dynamic range. Similarly, the voltage of the applied external field may be decreased to decrease the peak sound pressure level, root mean square sound pressure level, or system dynamic range. In this embodiment changing the voltage value range of the applied external field is analogous to the volume control of a traditional audio speaker system. It should be noted that this effect can also be achieved by current limiting or utilizing a combination of changing both voltage and a current limit.

As noted above, it is hypothesized that the sound reproduction results from electrons being emitted (liberated) from one or both of the first and second electrical grids 112 and 114 and accelerated to interact/collide with air molecules to create acoustic sound waves. In other words, it is believed that the acoustic sound output is generated by accelerating particles including electrons that then impart their kinetic energy to surrounding air molecules. This is fundamentally different than prior art systems that use moveable membranes or surfaces to push air molecules such as electrostatic speakers or electrodynamic speakers.

In some embodiments, as schematically shown in FIG. 1A, the first and second electrically conductive grids 112 and 114 are disposed at a small distance (e.g., on the order of millimeters or less (e.g., microns) from first and second opposing surfaces of the dielectric element 116, wherein the distance is selected to optimize performance. In other embodiments, the first electrically conductive grid 112 is in direct contact with the first surface of the dielectric element 116, and the second electrically conductive grid 114 is in direct contact with the second surface of the dielectric element 116. For example, the first and second electrically conductive grids 112 and 114 may be etched, deposited, sputtered, or otherwise placed on the first and second surfaces of the dielectric element 116.

The magnitude of the output voltage generated by the control system 120 is dependent upon factors such as the desired sound pressure level output, the geometry and conductivity of the electrical grid spacing or spacings and shape of the first and second electrical grids 112 and 114, the thicknesses of the first and second electrical grids 112 and 114, the thickness of the dielectric element 116 along with the electrical properties of the dielectric or insulating material of the dielectric element 116.

As noted above, the amount of electrons liberated and emitted from the first and second electrical grids 112 and 114 is function of a work function of the first and second electrical grids 112 and 114 and the applied electrical field (volts per meter). In general, the higher the voltage and the closer the spacing between the first and second electrical grids 112 and 114, the higher the audio sound pressure output. Thus, for a given output voltage from the control system 120, the sound pressure output will be higher for as the dielectric element 116 is made thinner. In some embodiments, the thickness of the dielectric element 116 is less than 0.0005 inches. In other embodiments, the thickness of the dielectric element 116 is 0.001, 0.002, 0.003. 004, or 0.005 inches.

In some embodiments, the dielectric element 116 is formed using any suitable dielectric or insulator material having properties such as (i) high dielectric strength, (ii) high tensile strength, (iii) the ability to be mechanically stable in extremely thin sheets or in a spray coat, high creep resistance, (iv) low hydroscopic absorption, etc. For example, the dielectric element 116 can be formed of plastic material including, but not limited to, Teflon, Mylar® & Melinex® polyethylene terephthalate (polyester PET) films, Polyethylene terephthalate (PET or PETE), High-density polyethylene (HDPE or PE-HD), Polyvinyl chloride (PVC or V), Low-density polyethylene (LDPE or PE-LD), Polypropylene (PP), Polystyrene (PS), Polyurethane (PUR), Acrylonitrile butadiene styrene (ABS), Teonex® & Kaladex® polyethylene naphthalate (polyester PEN) films, VALOX™ flame retardant polybutylene terephthalate blend (PBT/PET/PC) films, ULTEM™ flame retardant polyetherimide (PEI) films, LEXAN™ flame retardant polycarbonate (PC) films, Acetal, Vespel Polymide, ECTFE (ethylene chlorotrifluoroethylene), Tefzel (ethylene tetrafluoroethylene), FEP (fluorinated ethylene propylene), G10/FR-4 (a composite material that consists of glass fabric, electrical grade epoxy resin), GPO-3 (a glass reinforced thermoset polyester), LE linen phenolic sheet (phenolic resin impregnated into layers of woven linen fabric), Noryl, Modified PPO (engineered thermoplastic), Nylon, PAI (polyamide-imide), PBT (polybutylene terephthalate), Flexible EVA (ethylene vinyl acetate), PCTFE (polychlorotrifluoroethylene), PEEK (polyetheretherketone), PET (polyethylene terephthalate, semicrystalline), PFA (perfluoroalkoxy), Polycarbonate, PPS (Sustatron, Tecatron), PSU (polysulfone), PTFE (polytetrefluoroethylene), PVDF (polyvinylidene fluoride), Ultem® (polyetherimide), XX Paper Phenolic, all other plastics with suitable properties, and combinations thereof. Moreover, in some embodiments, the dielectric element 116 can be formed of a Kapton® Polyimide Film such as Kapton B, CRC, EN, EN-A, EN-C, EN-Y, EN-Z, FCRC, FN, FPC, FWN, FWR, GS, HN, HPP-ST, MT, FMT, MT+, PRN, PST, PV9100, RS, XP and Oasis Composite Films such as 200TRT515 and 120TWT561.

In other embodiments, the dielectric element 116 can be fabricated using other types of insulator materials such as wood, rubber, glass, varnish, fiberglass, porcelain, ceramic, quartz, (dry) cotton, (dry) paper, (dry) wood, and diamond. Again, as noted above, any suitable insulator may be utilized provided the insulating material provides high dielectric strength, excellent tensile strength, the ability to be mechanically stable in extremely thin sheets or in a spray coat, high creep resistance, and low hydroscopic absorption.

In some embodiments, first and second electrical grids 112 and 114 are formed of a metallic mesh material such as a copper mesh. In some embodiments, the mesh is 10, 20, 30, 40, 50, 60, 70, 80, 90, 100, 200, 300, 500, or 1,000 mesh. In some embodiments, the wire size of the mesh is 0.0001, 0.001, 0.005, or 0.010 inches in diameter. In some embodiments, the wire mesh utilizes square wire. In some embodiments, the first and second electrical grids 112 and 114 are deposited, etched, or otherwise placed on each side of the dielectric element 116. In some embodiments, one or both of the first and second electrical grids 112 and 114 are printed onto a polyimide sheet of other dielectric or insulator. In some embodiments, one or both of the first and second electrical grids 112 and 114 are formed from copper foil adhered or otherwise affixed to a polyimide sheet or other dielectric or insulator.

FIG. 1C schematically illustrates an audio sound reproduction apparatus, according to another exemplary embodiment of the disclosure. More specifically, FIG. 1C schematically illustrates an audio sound reproduction apparatus 101 which is similar in architecture and operation as the audio sound reproduction apparatus 100 of FIGS. 1A and 1B as discussed above, except that the audio sound reproduction apparatus 101 comprises a quantum audio transducer 130 which structurally differs from the quantum audio transducer 110. In particular, the quantum audio transducer 130 comprises a first electrically conductive grid 132 (alternatively, first electrical grid 132), a second electrically conductive grid 134 (alternatively, second electrical grid 134), and a dielectric element 136 (alternatively, dielectric sheet 136), wherein the electrically conductive grids 132 and 134 each comprise curved-shaped (e.g., dome shaped) contours/structures that are in partial contact with the dielectric element 136 on opposite sides thereof.

In particular, the first electrical grid 132 comprises a plurality of curved-shaped (e.g., dome shaped) structures that make partial contact with a first surface of the dielectric sheet 136, and the second electrical grid 134 comprises a plurality of curved-shaped (e.g., dome shaped) structures that make partial contact with a second surface of the dielectric sheet 136. In an exemplary embodiment, the first and second electrical grids 132 and 134 have structurally similar (e.g., mirror images) curve-shaped portions that are disposed in alignment on opposite sides of the dielectric sheet 136, as schematically illustrated in FIG. 1C. The curve-shaped contours of the first and second electrical grids 132 and 134 and their partial contact to the dielectric sheet 136 allows for very high electric fields by minimizing a separation distance, while still allowing for adequate interaction with the surrounding gas or air molecules.

In an experimental prototype of the exemplary architecture of a quantum audio transducer based on the exemplary framework of the quantum audio transducer 130 of FIG. 1C, the prototype audio transducer was constructed with each of the first and second electrical grids 132 and 134 implemented using a 4-inch square copper mesh, in particular, a number 30 mesh copper with 0.010 inch diameter copper wire, and the dielectric element 136 comprising a Kapton HN Film of 0.002 inch thickness (as is available from DuPont). The first and second electrical grids 132 and 134 (copper meshes) were placed into partial direct physical contact with the dielectric element 136 (Kapton dielectric film), and electrically isolated. The prototype audio transducer was driven with a modulated voltage having peak voltage of peak voltage of 1,500 volts. The prototype audio transducer was found to produce an audio signal output suitable for use with modern cell phones and portable speakers. In addition, no ozone (O₃) was generated.

FIGS. 1D and 1E schematically illustrate an audio sound reproduction apparatus, according to another exemplary embodiment of the disclosure. More specifically, FIGS. 1D and 1E schematically illustrate an audio sound reproduction apparatus 102 which is similar in architecture and operation as the audio sound reproduction apparatus 101 of FIG. 1C as discussed above, except that the audio sound reproduction apparatus 102 comprises a quantum audio transducer 140 which structurally differs from the quantum audio transducer 130. In particular, the quantum audio transducer 140 comprises a dielectric element 146 (alternatively, dielectric sheet 146) which comprises a plurality of perforations 146A which enable enhanced gas or airflow. As schematically illustrates in FIG. 1D, the first and second electrical grids 132 and 134 make partial contact to the regions of the dielectric sheet 146 around perimeter regions of the perforations 146A. For example, FIG. 1E is a schematic plan view of one side of the quantum audio transducer 140 along line 1E-1E in FIG. 1D, which shows the dielectric element 146 and the perforations 146A, and the first electrically conductive grid 132. The first electrically conductive grid 132 comprises a plurality of curved-shaped (e.g., dome shaped) contours/structures that are in partial contact with regions of the dielectric element 146 surrounding the perforations 146A, as schematically illustrated by bold dashed lines. While FIGS. 1D and 1E illustrates three perforation 146A for case of illustration and explanation, it is to be noted that in some embodiments, quantum audio transducers can be designed with dielectric elements having hundreds or thousands of perforations and curve-shaped structures.

It is to be noted that while FIGS. 1C and 1D schematically illustrate exemplary embodiments in which the first and second electrically conductive grids 132 and 134 each comprise three (3) curved-shaped structures, in other embodiments, the first and second electrically conductive grids 132 and 134 can be formed to have one, or two curved-shaped structures, or more than three curved-shaped structures (e.g., having hundreds or thousands of curve-shaped structures), depending on the given design. Furthermore, while FIGS. 1C and 1D schematically illustrate exemplary embodiments in which the first and second electrically conductive grids 132 and 134 each comprise curve-shaped structures, in other embodiments, one electrically conductive grid (e.g., the first electrically conductive grid 132) can be formed with curve-shaped structures, while the other electrically conductive grid (e.g., the second electrically conductive grid 134) can be planar such as shown in FIG. 1A), and vice versa.

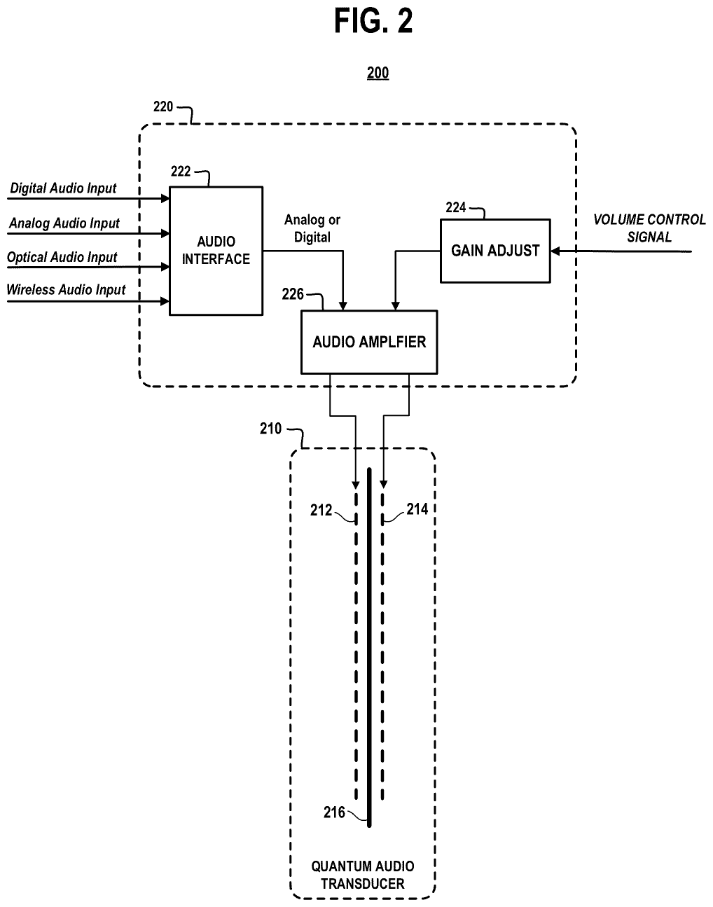

FIG. 2 schematically illustrates an audio sound reproduction apparatus, according to another exemplary embodiment of the disclosure. In particular, FIG. 2 schematically illustrates an audio sound reproduction apparatus 200 which comprises a quantum audio transducer 210 and a control system 220. The quantum audio transducer 210 comprises a first electrically conductive grid 212, a second electrically conductive grid 214, and a dielectric element 216 disposed between the first and second electrically conductive grids 212 and 214. The control system 220 is electrically coupled to both of the first and second electrically conductive grids 212 and 214. In some embodiments, the quantum audio transducer 210 is the same or similar in architecture and operation as the exemplary quantum audio transducer 110 of FIGS. 1A and 1B, or the quantum audio transducer 210 in FIG. 2 can be alternatively implemented with an architectural framework based on the exemplary quantum audio transducers 130 and 140 of FIG. 1C or 1D/1E.

The control system 220 is configured to control the operation of the quantum audio transducer 210. The control system 220 comprises an audio interface 222, an optional gain adjust element 224, and an audio amplifier 226. The audio interface 222 and the optional gain adjust element 224 are operatively coupled to the audio amplifier 226. In some embodiments, the control system 220 shown in FIG. 2 illustrate an exemplary architecture of the control system 120 of FIG. 1A.

The audio interface 222 is configured to receive and process one or more types of audio input signals such digital audio input signals, analog audio input signals, optical audio input signals, wireless audio input signals, etc. The digital audio input may be encoded according to any suitable audio encoding protocol. In addition, the optical audio input and the wireless audio input may be encoded using an analog or digital encoding protocols. The audio interface 222 extracts audio signals from the encoded input audio signals and outputs the extracted audio signals to the audio amplifier 226. In some embodiments, the audio interface 222 outputs digital audio signals to the audio amplifier 226. In other embodiments, the audio interface 222 outputs analog audio signals to the audio amplifier 226. In some embodiments, the audio amplifier 226 generates a modulated output voltage which is generated by modulating a voltage using the audio signal (analog or digital) which is output from the audio interface 222, and applies the modulated output voltage to the first and second electrically conductive grids 212 and 214 to generate a modulated electrical field between the first and second electrically conductive grids 212 and 214. The audio amplifier 226 may be of any suitable type, including but not limited to: Class A (Class A operation is typically defined as an amplifier where all of an amplifier's output devices must be conducting through the full 360 degree cycle of a waveform), Class B (Class B amplifiers are typically defined as amplifiers that utilize a push/pull arrangement in such a way that only half the output devices are conducting at any given time-one half covers the +180 degree portion of the waveform, while the other covers the −180 degree section), Class A/B (Class A/B amplifiers are typically defined as amplifiers that utilize a push/pull arrangement in such a way that each half of the output devices are conducting for 181 to 200 degrees, thereby eliminating any gap in waveform coverage), Class G/H (Class G & H amplifiers are typically defined as amplifiers that are variations of Class A/B utilizing voltage rail switching and rail modulation respectively), Class D (Class D amplifiers are typically defined as amplifiers that rapidly switch the output devices between the off and on state), and Class G and Class H amplifiers (Class-G amplifiers typically defines as amplifiers that run from a low voltage rail until the signal goes beyond a certain voltage, and a higher rail (or rails) is switched in. Class-H refines this to use a variable higher voltage rail (or rails), also known as a modulated rail.

The optional gain adjust element 224 is configured to adjust (increase or decrease) the magnitude of the modulated output voltage that is generated and output by the audio amplifier 226. By increasing or decreasing the magnitude of the modulated output voltage of the audio amplifier 226, the output sound pressure level (SPL) of the audio sound reproduction apparatus 200 increases or decreases, which is analogous to a typical audio volume control. The gain adjust element 224 may be set (i) automatically, a priori, based on external noise or listening environment, or (ii) manually by a user.

In some embodiments one or both of the electrically conductive grids 212 or 214 is in partial contact with the dielectric element 216, with the first electrically conductive grid 212 is in partial contact with the first surface of the dielectric element 216 and tor he second electrically conductive grid 214 is in partial contact with the second surface of the dielectric element 216. The partial contact allows for very high electric fields by minimizing separation distance while still allowing for adequate interaction with the surrounding gas or air molecules. In some embodiments the dielectric element 216 is perforated to allow for enhanced gas or airflow. The dielectric element 216 may be so configured to allow for one or both of the electrically conductive grids 212 or 214 to be in partial contact with the dielectric element 116.

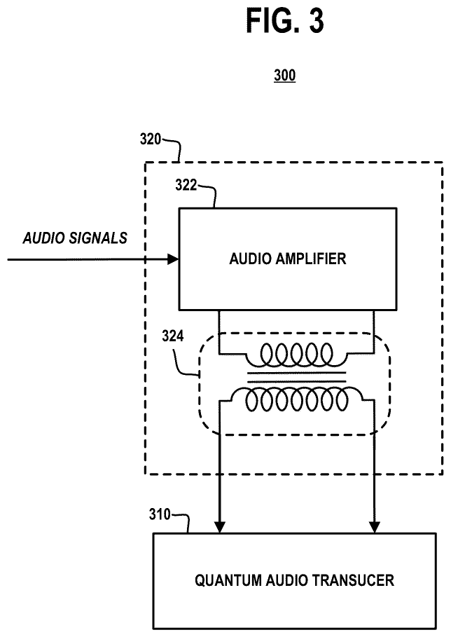

FIG. 3 schematically illustrates an audio sound reproduction apparatus, according to another exemplary embodiment of the disclosure. In particular, FIG. 3 schematically illustrates an audio sound reproduction apparatus 300 which comprises a quantum audio transducer 310 and a control system 320. The quantum audio transducer 310 can be implemented using any of the exemplary embodiments of quantum audio transducers (e.g., quantum audio transducer 110 or 120, 210) as disclosed herein. The control system 320 comprises an audio amplifier 322 and a transformer 324. The audio amplifier 322 comprises an output that is coupled to the transformer 324, and the transformer 324 is coupled to the quantum audio transducer 310. The audio amplifier 322 is configured to receive an audio input signal and generate a modulated output voltage. In some embodiments, the transformer 324 is configured to perform step-up voltage transformation, wherein the modulated output voltage from the audio amplifier 322 to be stepped up to a target voltage (e.g., 1,500 volts) to drive the quantum audio transducer 310.

In some embodiments, the audio amplifier 322 can be implemented using a standard amplifier architecture configured to drive passive electrodynamic audio speakers operating at 8, 4, or 2 ohm loads, and the transformer 324 can be implemented using a standard audio transformer. By way of example, for purposes of testing, a prototype audio sound production system was built in which the audio amplifier 322 and transformer 324 were implemented using commercially available components. In particular, the audio amplifier 322 was implemented using a commercially available amplifier, e.g., a Fosi Audio BT20A Bluetooth 5.0 Stereo Audio 2 Channel Amplifier Receiver Mini Hi-Fi Class D Integrated Amp 2.0 CH for Home Speakers 100 W×2 with Bass and Treble Control TPA3116 (with Power Supply). Further, the transformer 324 was implemented using a Hammond 1650RA transformer which is typically utilized as an output transformer for high fidelity tube audio amplifiers. In the exemplary prototype configuration, the output of the audio amplifier 322 was operatively connected to a 4 ohm tap of a secondary side of the Hammond 1650RA transformer, with a primary side of the transformer operatively coupled to the quantum audio transducer 310. The primary side of the Hammond 1650RA transformer has an impedance of approximately 10,000 ohms and both sides have a dielectric breakdown voltage of at least 3,500 volts. For reference, the primary side center tap was not utilized. The Hammond 1650RA transformer is configured as an approximately 20:1 step-up transformer, allowing the voltage from the audio amplifier 322 to be stepped up to approximately 1,500 volts and drive the quantum audio transducer 310. The experiments performed using the prototype sound reproduction system indicated that the quantum audio transducer was highly efficient and required a power of only 2 watts to create 127 dB. SPL. The above-noted system components were chosen for their availability and functionality, not for cost, size, weight, or efficiency.

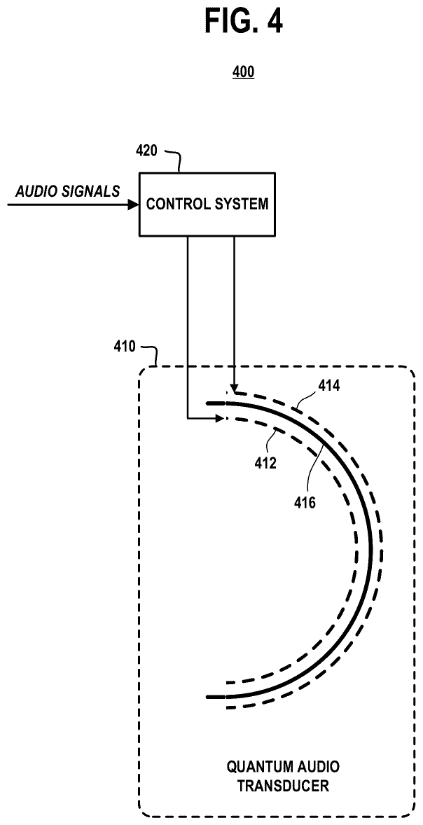

FIG. 4 schematically illustrates an audio sound reproduction apparatus, according to another exemplary embodiment of the disclosure. In particular, FIG. 4 schematically illustrates an audio sound reproduction apparatus 400 which comprises a quantum audio transducer 410 and a control system 420. The control system 420 can be implemented using the same or similar control system architectures as discussed herein. The quantum audio transducer 410 comprises a first electrically conductive grid 412, a second electrically conductive grid 414, and a dielectric element 416 disposed between the first and second electrically conductive grids 412 and 414. In the exemplary embodiment of FIG. 4, the first and second electrically conductive grids 412 and 414, and the dielectric element 416 are curve-shaped elements, as opposed to planar elements as shown in FIGS. 1A, 1B, and 2. In some embodiments, the first and second electrically conductive grids 412 and 414, and the dielectric element 416 are parabolic-shaped elements, or hemispherical-shaped. The curve-shaped configuration of the quantum audio transducer 410 provides directivity of the acoustic sound waves generated by the quantum audio transducer 410

In other embodiments, a quantum audio transducer can have first and second electrically conductive grids and dielectric elements that are geometrically configured using other geometric shapes such as circles, concentric circles, concentric, parabola or semi-parabola, conical shapes or portions thereof, aspheric shapes or portions, etc., as desired, to achieve a desired audio field of coverage. In all instance, the dielectric element can be formed or otherwise shaped to the desired form with the first and second electrically conductive grids etched, deposited, sputtered, or otherwise placed on the opposing surface of the dielectric element.

In some embodiments one or both of the electrically conductive grids 412 or 414 is in partial contact with the dielectric element 416, with the first electrically conductive grid 412 is in partial contact with the first surface of the dielectric element 416 and/or he second electrically conductive grid 414 is in partial contact with the second surface of the dielectric element 416. The partial contact allows for very high electric fields by minimizing separation distance while still allowing for adequate interaction with the surrounding gas or air molecules. In some embodiments the dielectric element 416 is perforated to allow for enhanced gas or airflow. The dielectric element 416 may be so configured to allow for one or both of the electrically conductive grids 412 or 414 to be in partial contact with the dielectric element 116.

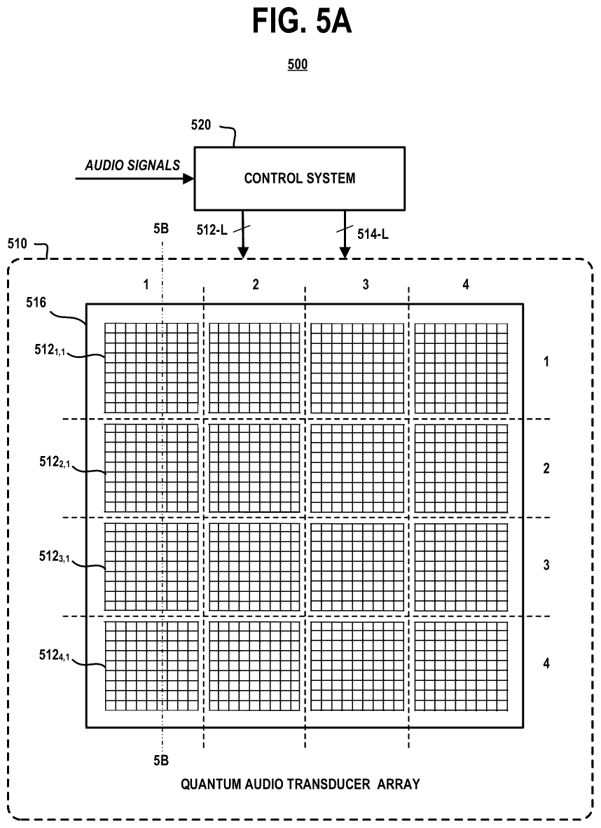

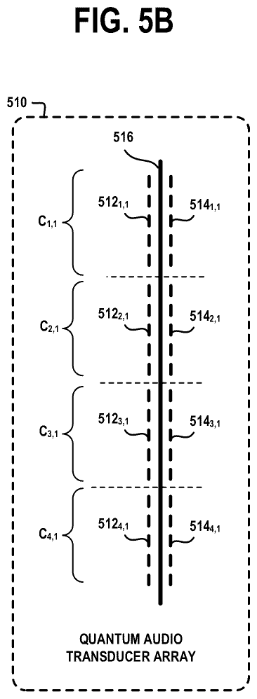

FIGS. 5A and 5B schematically illustrate an audio sound reproduction apparatus, according to another exemplary embodiment of the disclosure. In particular, FIGS. 5A and 5B schematically illustrate an audio sound reproduction apparatus 500 which comprises a quantum audio transducer array to enable acoustic beam steering, according to an exemplary embodiment of the disclosure. The audio sound reproduction apparatus 500 comprises a quantum audio transducer array 510, and a control system 520. FIG. 5A schematically illustrates a frontside plan view of the quantum audio transducer array 510, while FIG. 5B is a schematic cross-sectional side view of the quantum audio transducer array 510 along line 5B-5B in FIG. 5A. While not specifically shown in FIGS. 5A and 5B, the quantum audio transducer array 510 may be housed in an enclosure for handling, acoustic frequency range control, or acoustic coverage pattern.

As shown in FIGS. 5A, the quantum audio transducer array 510 comprises a two-dimensional array of transducer cells C_{i,j}, which are addressable by a row index i (e.g., i=1, 2, 3, 4) and a column index j (e.g., j=1, 2, 3, 4). While FIG. 5A shows an exemplary rectangular array which comprises a 4×4 array of sixteen (16) transducer cells (e.g., 4 rows and 4 columns, indexed as C_{i,j}), where M×N is an array of transducer cells where M=N. It is to be understood that in other embodiments, the quantum audio transducer array 510 can also be configured to have an M×N array of transducer cells, where MAN. Moreover, as schematically shown in FIGS. 5A and 5B, each transducer cell C_{i,j} comprises a first electrically conductive grid 512_{i,j} and a second electrically conductive grid 514_{i,j}, which are separated by a dielectric element 516. For example, 5B specifically illustrates four (4) transducer cells C_{1,1}, C_{2,1}, C_{3,1}, and C_{4,1} (e.g., along column 1 of the quantum audio transducer array 510), wherein each transducer cell C_{1,1}, C_{2,1}, C_{3,1}, and C_{4,1} comprises a respective pair of first and second electrically conductive grids 512_{1,1}/514_{1,1}, 512_{2,1}/514_{2,1}, 512_{3,1}/514_{3,1}, and 512_{4,1}/514_{4,1}. While FIGS. 5A and 5B show an exemplary embodiment in which the array of transducer cells C_{i,j} share a common continuous dielectric element 516, in other embodiments, the transducer cells C_{i,j} may comprise separate dielectric elements (denoted 516_{i,j}) that are disposed between respective pairs of first and second electrically conductive grids 512_{i,j}/514_{i,j}.

It is to be understood that the quantum audio transducer array 510 can be constructed using the same or similar materials and structural configurations as discussed above for the exemplary quantum audio transducers 110, 130, or 140 of FIG. 1A/1B, FIG. 1C, or FIGS. 1D/1E. In this regard, each transducer cell C_{i,j} of the quantum audio transducer array 510 may be considered to be single instance of the quantum audio transducer 110, 130 or 140, wherein the control system 520 is configured to individually and separately control each transducer cell C_{i,j} of the quantum audio transducer array 510, as desired. In particular, as schematically shown in FIG. 5A, the control system 520 is coupled to each of the transducer cells C_{i,j} of the quantum audio transducer array 510 using respective control lines 512-L and 514-L. The control lines 512-L comprise individual control lines that are coupled to respective ones of the first electrically conductive grids 512_{i,j} of the transducer cells C_{i,j}, and the control lines 514-L comprise individual control lines that are coupled to respective ones of the second electrically conductive grids 514_{i,j} of the transducer cells C_{i,j}. In one non-limiting exemplary embodiment, assuming that the quantum audio transducer array 510 comprises a 4×4 array of sixteen (16) transducer cells, the set of control lines 512-L would comprise 16 individual control lines coupled to respective ones of the first electrically conductive grids 512_{i,j} of the transducer cells C_{i,j}, while the set of control lines 514-L would comprise 16 individual control lines coupled to respective ones of the second electrically conductive grids 514_{i,j} of the transducer cells C_{i,j}.

In an exemplary embodiment, the control system 520 is configured to selectively turn on and turn off the individual transducer cells C_{i,j} of the quantum audio transducer array 510, to implement different modes of operation. For example, in one exemplary mode of operation, the control system 520 can selectively turn on and turn off individual transducer cells C_{i,j} of the quantum audio transducer array 510 as desired to achieve acoustical output beam steering (via applying control signals to the individual transducer cells with different phases/delays) to thereby change the directionality of the acoustic sound output or otherwise alter an audio coverage field of coverage.

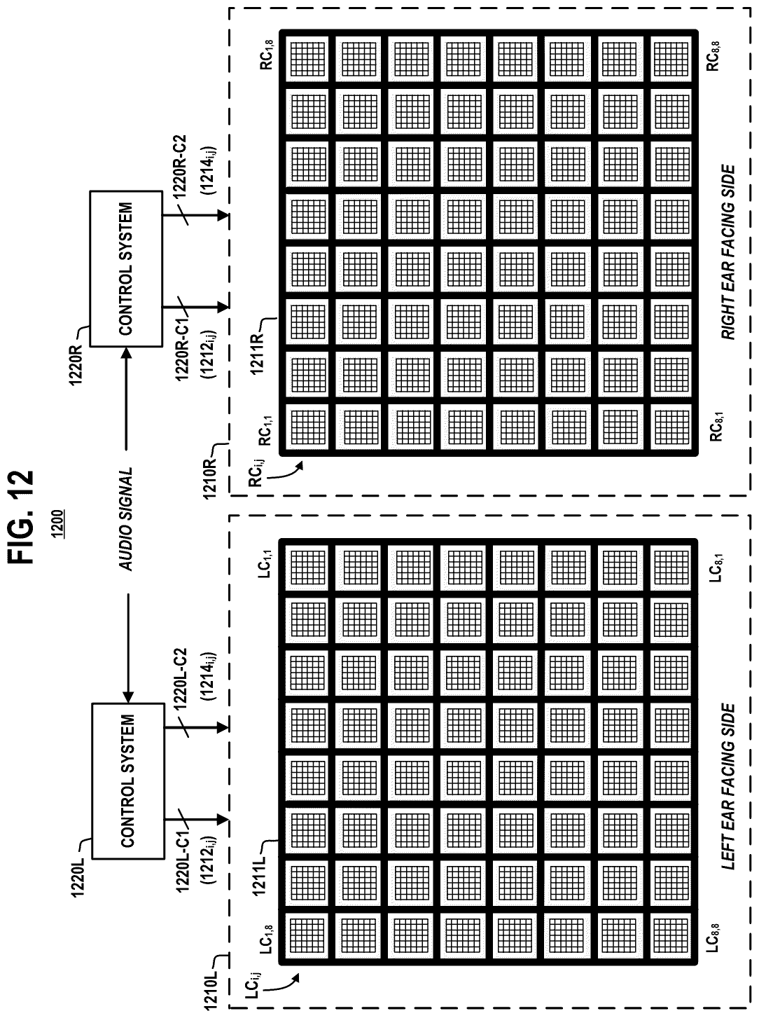

FIGS. 5A and 5B schematically illustrate the quantum audio transducer array 510 having a N×N array of individual transducer cells C_{i,j}, however it should be understood that the present the array may be in any combination of rows and columns, where the rows and columns are differing or the same number. Additionally, the geometric arrangement of cells can be in any specific geometric arrangement. Indeed, the individual cells may be of different sizes and shapes. In one embodiment, multiple cells are so configured to fit within the size of an earbud (e.g., as shown and discussed below in conjunction with FIG. 12). The cells are so arranged to provide three-dimensional sound reproduction. Tools such as Dolby Atmos provide for a more realistic and immersive audio experience that can be used for movies, music, gaming, and more. The present invention overcomes the limitation of earbuds limited to single transducers in each earbud, and the reliance on binaural processing is the ability to use the differences in sound between the two cars to identify sounds and determine their location. At present, multiple transducer configurations are limited to larger over the car headsets for head worn audio systems.

In other exemplary operating modes, the control system 520 can generate output voltages (in phase, without delay) to one or more individual transducer cells C_{i,j} of the quantum audio transducer array 510 as desired, to achieve a desired output sound pressure level (e.g., volume control) and/or to increase or decrease dynamic range. In addition, the control system 520 may be optionally configured to selectively turn on and turn off individual transducer cells C_{i,j} of the quantum audio transducer array 510 by user command or autonomously based on measurements conducted in the listening environment. The control system 520 may also turn on and off quantum audio transducer cells based upon the desired output sound pressure level and or to increase or decrease dynamic range.

While FIGS. 5A and 5B schematically illustrate the quantum audio transducer array 510 having a N×N array of individual transducer cells C_{i,j}, in other embodiments, a quantum audio transducer array may be implemented as a single line array (e.g., 1×N) of individual transducer cells. In other embodiments, the control system 520 can operate the quantum audio transducer array 510 as a single line array by activating only a single row or a single column of individual transducer cells C_{i,j}. Moreover, a quantum audio transducer array can be geometrically shaped for a specific audio coverage pattern. Moreover, while FIGS. 5A and 5B schematically illustrate the quantum audio transducer array 510 having a planar rectangular-shaped configuration, in other embodiments, the various components of the individual transducer cells C_{i,j} can be shaped into one or more of a parabola, a conic section, a portion of a conic section, aspheric, or a portion of an asphere, are any suitable geometric shape as desired, to achieve a desired audio field of coverage.

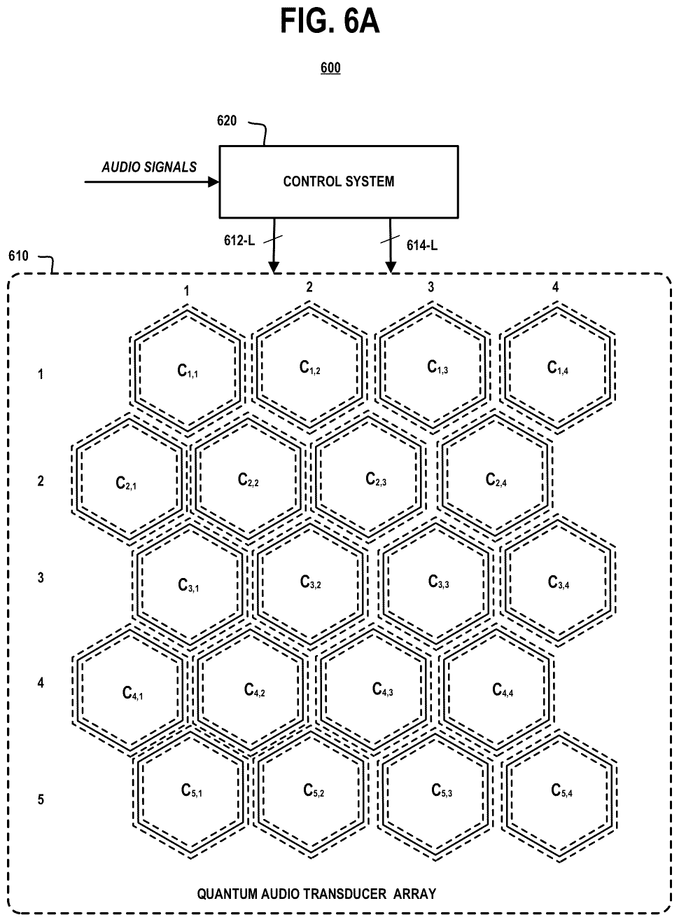

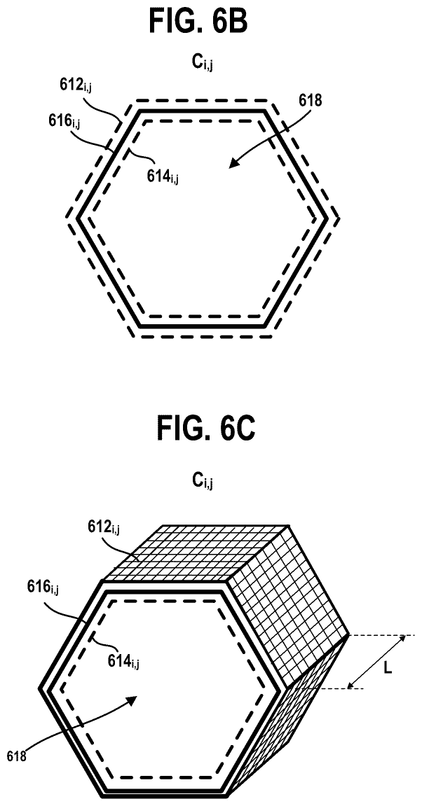

FIGS. 6A, 6B, and 6C schematically illustrate an audio sound reproduction apparatus, according to another exemplary embodiment of the disclosure. In particular, FIGS. 6A, 6B, and 6C schematically illustrate an audio sound reproduction apparatus 600 which comprises a quantum audio transducer array 610, and a control system 620. FIG. 6A schematically illustrates a frontside plan view of the quantum audio transducer array 610 which comprises plurality of hexagon-shaped transducer cells C_{i,j} arranged in a honeycomb array. The transducer cells C_{i,j} are individually addressable by a row index i (e.g., i=1, 2, 3, 4, 5) and a column index j (e.g., j=1, 2, 3, 4). FIG. 6A shows an exemplary honeycomb array which comprises a twenty (20) transducer cells (e.g., 5 rows and 4 columns, indexed as C_{i,j}), it is to be understood that in other embodiments, the quantum audio transducer array 610 can be configured to have any number of hexagonal-shaped transducer cells.

Moreover, as schematically shown in FIGS. 6B and 6C, in some embodiments, each hexagonal-shaped transducer cell C_{i,j} comprises an elongated hexagonal-shaped element (e.g., length L) which comprises a first electrically conductive grid 612_{i,j}, a second electrically conductive grid 614_{i,j}, which are separated by a dielectric element 616_{i,j}. In some embodiments, the first electrically conductive grid 612_{i,j} and the second electrically conductive grid 614_{i,j} are in direct contact with the dielectric element 616_{i,j}. In some embodiments, the first electrically conductive grid 612_{i,j} and/or the second electrically conductive grid 614_{i,j} are in partial contact with the dielectric element 616_{i,j} to enhance electric field strength. In some embodiments the dielectric element 616_{i,j} is perforated to allow for enhanced gas or airflow. The dielectric element 616_{i,j} may be so configured to allow for one or both of the electrically conductive grids 612_{i,j} or 614_{i,j} to be in partial contact with the dielectric element 616_{i,j}.

In operation, the acoustic sound waves generated by the hexagonal-shaped transducer cell C_{i,j} are emitted from an open inner region 618 of the hexagonal-shaped transducer cell C_{i,j}. It is to be understood that the hexagonal-shaped transducer cells C_{i,j} of the quantum audio transducer array 610 can be constructed using the same or similar materials as discussed above for the quantum audio transducers 110, 130, or 140 of FIG. 1A/1B, 1C, or 1D/1E.

The control system 620 is configured to individually and separately control each transducer cell C_{i,j} of the quantum audio transducer array 610, as desired. For example, as schematically shown in FIG. 6A, the control system 620 is coupled to each of the transducer cells C_{i,j} of the quantum audio transducer array 610 using respective control lines 612-L and 614-L. The control lines 612-L comprise individual control lines that are coupled to respective ones of the first electrically conductive grids 612_{i,j} of the transducer cells C_{i,j}, and the control lines 614-L comprise individual control lines that are coupled to respective ones of the second electrically conductive grids 614_{i,j} of the transducer cells C_{i,j}. For example, assuming that the quantum audio transducer array 610 comprises twenty (20) transducer cells, the set of control lines 612-L would comprise 20 individual control lines coupled to respective ones of the first electrically conductive grids 612_{i,j} of the transducer cells C_{i,j}, while the set of control lines 614-L would comprise 20 individual control lines coupled to respective ones of the second electrically conductive grids 614_{i,j} of the transducer cells C_{i,j}.

In other embodiments, the second (outer) electrically conductive grids 614_{i,j} of the transducer cells C_{i,j} may be commonly connected, in which case the control lines 614-L would include a single control line coupled to each of the second (outer) electrically conductive grids 614_{i,j} of the transducer cells C_{i,j}. In other embodiments, the first (inner) electrically conductive grids 612_{i,j} of the transducer cells C_{i,j} may be commonly connected, in which case the control lines 612-L would include a single control line coupled to each of the first (inner) electrically conductive grids 612_{i,j} of the transducer cells C_{i,j}.

In an exemplary embodiment, the control system 620 is configured to selectively turn on and turn off the individual hexagonal-shaped transducer cells C_{i,j} of the quantum audio transducer array 610, to implement different modes of operation. For example, the control system 620 can selectively turn on and turn off individual hexagonal-shaped transducer cells C_{i,j} of the quantum audio transducer array 610 to achieve a desired output sound pressure level (e.g., volume control) and/or to increase or decrease dynamic range. In other embodiments, the control system 620 can be configured to selectively turn on and turn off individual hexagonal-shaped transducer cells C_{i,j} of the quantum audio transducer array 610 to achieve based on user command or autonomously based on measurements conducted in the listening environment.

It is to be noted that the exemplary honeycomb array configuration of the quantum audio transducer array 610, is a non-limiting, exemplary embodiment of one of various geometric shapes that can be utilized to implement a quantum audio transducer array. For example, instead of the elongated hexagonal-shaped transducer cells C_{i,j} of the quantum audio transducer array 610 as shown in FIG. 6C, a quantum audio transducer array can be implemented using elongated cylindrical-shaped transducer cells, elongated rectangular-shaped transducer cells, etc. Moreover, while the first (inner) electrically conductive grids 612_{i,j} and second (outer) electrically conductive grids 614_{i,j} of the transducer cells C_{i,j} are schematically shown as electrical grids, the first (inner) electrically conductive grids 612_{i,j} and second (outer) electrically conductive grids 614_{i,j} can be implemented using solid metal/metallic sheets, or a combination of solid metal/metallic sheets, grid structures, and/or perforated metal/metallic sheets.

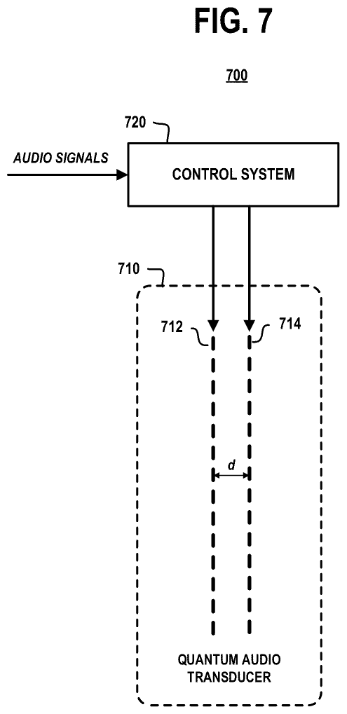

FIG. 7 schematically illustrates an audio sound reproduction apparatus, according to an exemplary embodiment of the disclosure. In particular, FIG. 7 schematically illustrates an audio sound reproduction apparatus 700 which comprises a quantum audio transducer 710, and a control system 720. The quantum audio transducer 710 comprises a first electrical grid 712 and a second electrical grid 714, which are spaced apart at a distance d. The audio sound reproduction apparatus 700 is similar in architecture and operation as the audio sound production system 100 of, e.g., FIGS. 1A and 1B. However, the quantum audio transducer 710 does not implement a dielectric element between the first and second electrical grids 712 and 714, but rather relies on an air gap separation (of distance d) as the insulator/dielectric medium between the first and second electrical grids 712 and 714.

As with the exemplary embodiments discussed above, the control system 720 generates a modulated output voltage which is modulated by an input audio signal, and applies the modulated output voltage to the first and second electrical grids 712 and 714 to generate a relatively high electric field between the first and second electrical grids 712 and 714 to generate acoustic sound pressure, thereby transducing the audio input signal to acoustic sound. In an exemplary embodiment, the first electrical grid 712 is comprised of a given material or composition of materials having a work function which is, e.g., about 4.0 eV or less. For example, in an exemplary non-limiting embodiment, the first electrical grid 712 is comprised of zinc, and the second electrical grid 2114 is comprised of copper.

While FIG. 7 shows the first and second electrical grids 712 and 714 as planar elements, in other embodiments, the shapes of the first and second electrical grids 712 and 714 may be arranged in any geometric pattern so as to provide acoustic sound directivity or otherwise achieve a desired audio field, such as curve-shaped structures of the quantum audio transducer 410 of FIG. 4, and other curved shapes as discussed above. In another exemplary embodiment, quantum audio transducer array may be constructed with multiple transducer cells that are implemented using the quantum audio transducer 710 of FIG. 7, similar to the exemplary quantum audio transducer array 510 of FIGS. 5A and 5B, wherein the individual quantum audio transducer cells can be controlled in a manner such that the individual cells are operated (e.g., turned off, turned on, operated with different power levels, etc.) independently from each other, or in unison, or some combination thereof, to enable static and/or active beam steering.

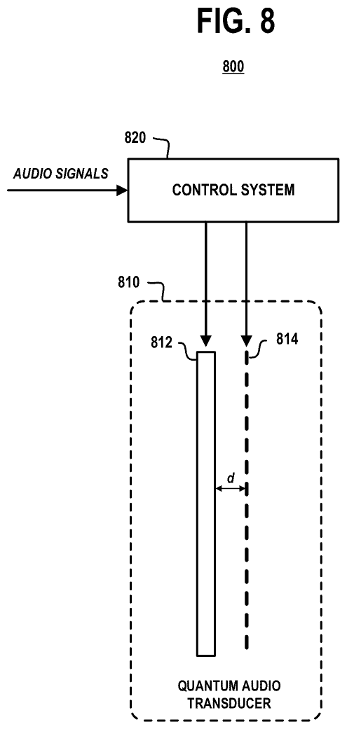

FIG. 8 schematically illustrates an audio sound reproduction apparatus, according to an exemplary embodiment of the disclosure. More specifically, FIG. 8 schematically illustrates an audio sound reproduction apparatus 800 which comprises a quantum audio transducer 810, and a control system 820. The quantum audio transducer 810 comprises an electrically conductive sheet 812 and an electrical grid 814 spaced apart at a distance d. The audio sound reproduction apparatus 800 is similar in architecture and operation as, e.g., the audio sound production systems 100 and 700 of FIGS. 1A, 1B, and FIG. 7. As with the quantum audio transducer 710 of FIG. 7, the quantum audio transducer 810 does not implement a dielectric element between the first and second electrical grids 712 and 714, but rather relies on an air gap separation (of distance d) as the insulator/dielectric medium between the electrically conductive sheet 812 and the electrical grid 814.

As with the exemplary embodiments discussed above, the control system 820 generates a modulated output voltage which is modulated by an input audio signal, and applies the modulated output voltage to the electrically conductive sheet 812 and the electrical grid 814 to generate a relatively high electric field between the electrically conductive sheet 812 and the electrical grid 814 to generate acoustic sound pressure, thereby transducing the audio input signal to acoustic sound. In some embodiments, the electrically conductive sheet 812 is comprised of a given material or composition of materials having a work function which is, e.g., about 4.0 eV or less.

In an experimental prototype of a quantum audio transducer based on the exemplary configuration of the quantum audio transducer 810 of FIG. 8, an electrically conductive sheet 812 comprised of zinc (Zn), and an electrical grid 814 comprised of a copper (Cu) mesh, and separated by a distance of a few millimeters (e.g., 2 mm), was found to reproduce sound in response to an amplified AC voltage audio signal being applied across the electrically conductive zinc sheet and the copper electrical grid, which is an unexpected result. As noted above, it is hypothesized that the sound reproduction results from one or more of the following mechanisms: (i) electrons being emitted from the surface of the low work function electrically conductive sheet 812 and accelerated to interact/collide with air molecules; (ii) polarization of air and/or (iii) the partial ionization of air.

While FIG. 8 shows the electrically conductive sheet 812 and the electrical grid 814 as planar elements, in other embodiments, the shapes of the electrically conductive sheet 812 and the electrical grid 814 may be arranged in any geometric pattern so as to provide acoustic sound directivity or otherwise achieve a desired audio field, such as curve-shaped structures of the quantum audio transducer 410 of FIG. 4, and other curved shapes as discussed above. In another exemplary embodiment, quantum audio transducer array may be constructed with multiple transducer cells that are implemented using the quantum audio transducer 810 of FIG. 8, similar to the exemplary quantum audio transducer array 510 of FIGS. 5A and 5B, wherein the individual quantum audio transducer cells can be controlled in a manner such that the individual cells are operated (e.g., turned off, turned on, operated with different power levels, etc.) independently from each other, or in unison, or some combination thereof, to enable static and/or active beam steering.

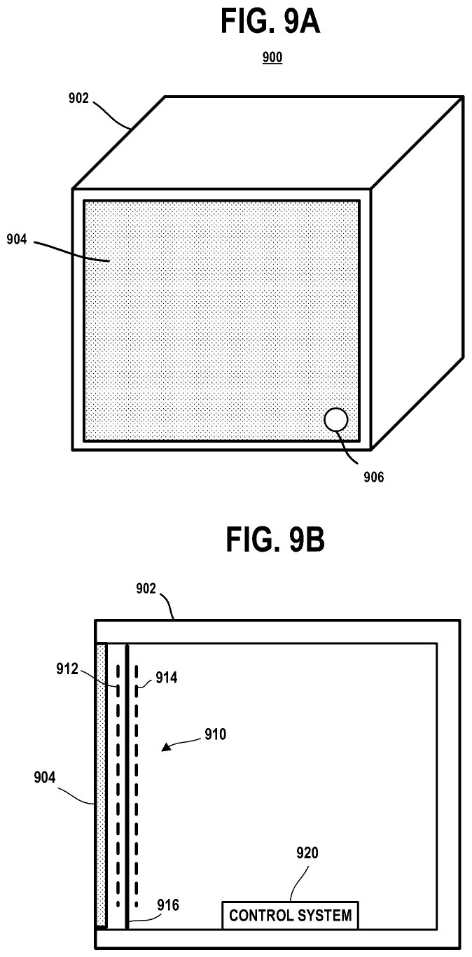

It is to be understood that the exemplary audio sound reproduction apparatus 100, 200, 300, 400, 500, 600, 700, and 800 as discussed above would be disposed within suitable housings or enclosures for purposes such providing structural handling of the components, acoustic frequency range control, and/or acoustic coverage pattern, etc. For example, FIGS. 9A and 9B schematically illustrate an audio sound reproduction apparatus, according to an exemplary embodiment of the disclosure. In particular, FIGS. 9A and 9B schematically illustrate an audio sound reproduction apparatus 900 which comprises an enclosure 902 which houses components including a quantum audio transducer 910 (or quantum audio transducer array), and a control system 920 that is configured to control the operation of the quantum audio transducer 910 (or quantum audio transducer array).

In some embodiments, the enclosure 902 comprises a frontside screen 904 (e.g., a standard speaker screen), and a port 906 to provide a ported enclosure. As shown in FIG. 9B, the quantum audio transducer 910 (or quantum audio transducer array) is fixedly disposed within the enclosure 902 and disposed in the frontside region of the enclosure 902 behind the screen 904. In the exemplary embodiment shown in FIG. 9B, the quantum audio transducer 910 comprises a first electrically conductive grid 912, a second electrically conductive grid 914, and a dielectric element 916 disposed between the first and second electrically conductive grids 912 and 914, similar to the exemplary quantum audio transducer 110 of FIGS. 1A, 1B, and 1C. In other embodiments, the quantum audio transducer 910 can be configured using the exemplary quantum audio transducer architectures of exemplary audio sound reproduction apparatus 200, 300, 400, 500, 600, 700, or 800, as discussed above.

The port 904 is configured to allow air to flow out from the inside of the enclosure 902 during operation quantum audio transducer 910 when sound pressure is generated within the enclosure 904. The port 904 can be optimized in terms of, e.g., size and location to optimize the acoustic response. In the exemplary embodiment of FIG. 9A, the port 906 is disposed in the frontside of the speaker enclosure 902 for directionality, and is configured to control phase distortion to prevent cancelation of low frequency audio.

In other exemplary embodiment, the enclosure 902 can be configured to be air tight so that air can be evacuated from within the enclosure 902 with reduced internal pressure within the enclosure. The reduced internal pressure within the enclosure 902 provides an environment with a reduced air/gas pressure level at a back side of quantum audio transducer 910 (e.g., behind the dielectric element 916), which enhances a low frequency response for a given speaker size, while also minimizing resonant frequencies and phase cancellation issues which could otherwise occur as a result of acoustic signals (sound waves) generated at the back side of the back side of quantum audio transducer 910 facing inside the enclosure 902. Indeed, reducing the pressure behind the quantum audio transducer 910 (e.g., within the enclosure 902) has the effect of reducing or eliminating the generation of resultant out-of-phase acoustic signals at the back side of quantum audio transducer 910, which in turn eliminates issues of phase cancellation for low frequencies. This allows the size of the enclosure 902 to be made extremely thin.

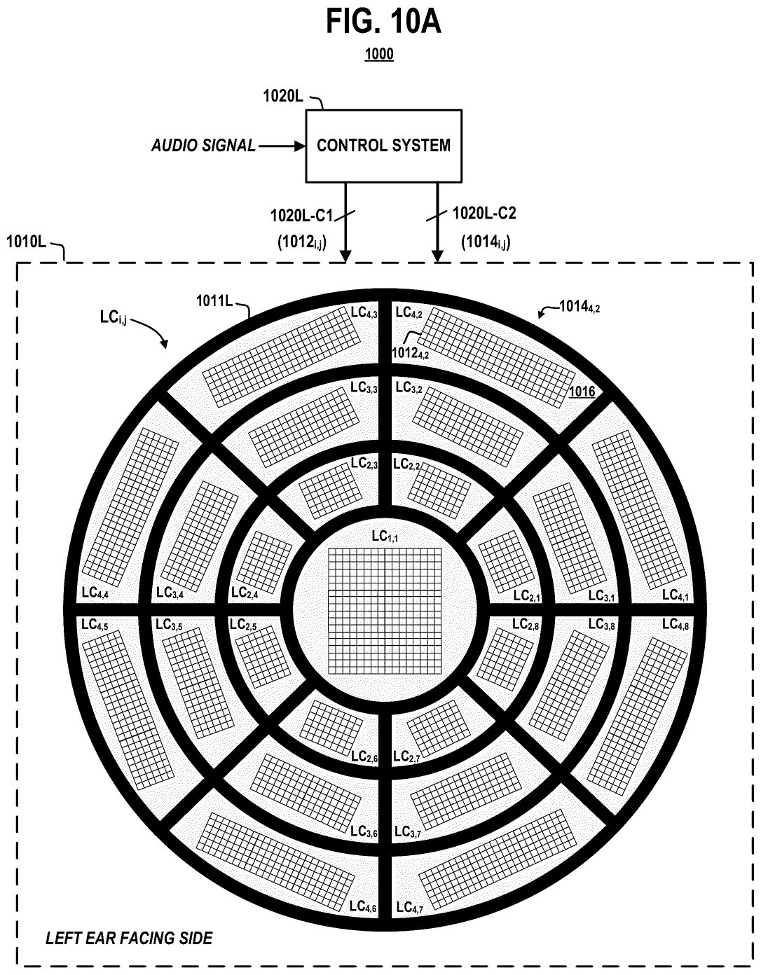

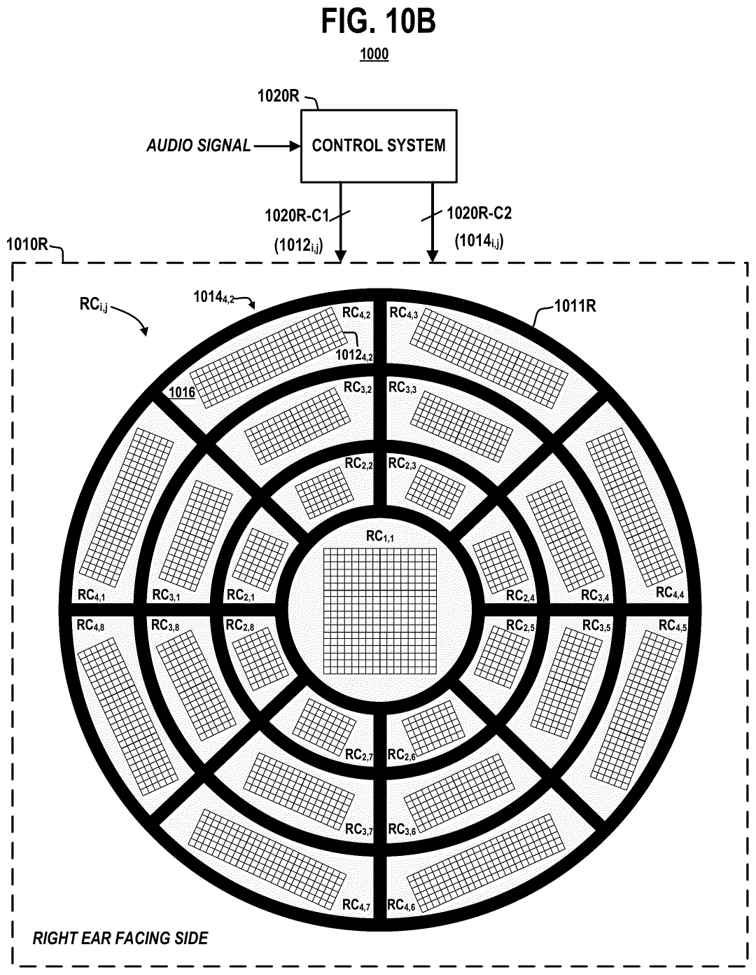

In other embodiments, quantum audio transducers can be used to implement various types of earphone devices, exemplary embodiments of which will be explained now in further detail with reference to FIGS. 10A, 10B, 11A, 11B, and 12. It is to be noted that the term “earphones” as used herein broadly refers to various types of earphones including, but not limited to, “in ear” earphones (also referred to as earbuds), “over ear” earphones (also referred to as head phones), “on ear” earphones, “bone conduction” earphones, “ear canal” earphones (e.g., hearing aids), “outer ear” earphones, “open ear” earphones, etc., wherein the earphones can be wired or wireless earphones.

FIGS. 10A and 10B schematically illustrate an audio sound reproduction apparatus which comprises earphones, according to an exemplary embodiment of the disclosure. In particular, FIGS. 10A and 10B collectively illustrate an audio sound reproduction apparatus 1000 which comprises a left earphone 1010L and corresponding control system 1020L (FIG. 10A), and a right earphone 1010R and corresponding control system 1020R (FIG. 10B). The left earphone 1010L comprises a circular/radial array of audio transducer cells, generally denoted LC_{i,j}, wherein the transducer cells are individually addressable by a first index i (e.g., i=1, 2, 3, 4) and a second index j (e.g., j=1, 2, 3, 4, 5, 6, 7, and 8). Similarly, the right earphone 1010R comprises a circular/radial array of audio transducer cells, generally denoted RC_{i,j}, wherein the transducer cells are individually addressable by a first index i (e.g., i=1, 2, 3, 4) and a second index j (e.g., j=1, 2, 3, 4, 5, 6, 7, and 8).

The left earphone 1010L comprises an insulating frame 1011L which is structurally configured to mount and position the audio transducer cells LC_{i,j} in a circular/radial array configuration. Similarly, the right earphone 1010R comprises an insulating frame 1011R which is structurally configured to mount and position the audio transducer cells RC_{i,j} in a circular/radial array configuration. It is to be noted that in some embodiments, the array of audio transducer cells LC_{i,j} and RC_{i,j} of the left and right earphones 1010L and 1010R can be constructed, for example, using the same or similar materials and structural configurations as discussed above for exemplary quantum audio transducers 110, 130, and 140 as schematically illustrated in FIGS. 1A/1B, 1C, and 1D/1E. In this regard, each of the audio transducer cells LC_{i,j} and RC_{i,j} of the left and right earphones 1010L and 1010R can be considered as a single instance of one of the quantum audio transducers 110, 130 or 140.

For purposes of illustration, in the exemplary embodiment shown in FIGS. 10A and 10B, each of the audio transducer cells LC_{i,j} and RC_{i,j} is shown as being implemented using the exemplary architecture of the quantum audio transducer 110 of FIGS. 1A and 1B, wherein each of the audio transducer cells LC_{i,j} and RC_{i,j} comprises a respective first electrically conductive grid (generally denoted 1012_{i,j}), a second electrically conductive grid (generally denoted 1014_{i,j}), and a dielectric element 1016 disposed between the first and second electrically conductive grids.

In particular, FIG. 10A schematically illustrates one side (i.e., left car facing side) of the array of audio transducer cells LC_{i,j} of the left earphone 1010L, which shows the first electrically conductive grid 1012_{i,j} of each audio transducer cell LC_{i,j} disposed adjacent to a front side of the respective dielectric element 1016 of each audio transducer cell LC_{i,j}, while the second electrically conductive grid 1014_{i,j} of each audio transducer cell LC_{i,j} is disposed adjacent to the opposite (back) side of the respective dielectric element 1016 which faces away from an individual's leaf car. For case of illustration, FIG. 10A includes only specific reference labels of the first electrically conductive grid 101242, the second electrically conductive grid 101442, and the dielectric element 1016 of the audio transducer cell LC_{4,2}.

Similarly, FIG. 10B schematically illustrates one side (i.e. right car facing side) of the array of audio transducer cells RC_{i,j} of the right earphone 1010R, which shows the first electrically conductive grid 1012_{i,j} of each audio transducer cell RC_{i,j} disposed adjacent to a front side of the respective dielectric element 1016 of each audio transducer cell RC_{i,j}, while the second electrically conductive grid 1014_{i,j} of each audio transducer cell RC_{i,j} is disposed adjacent to the opposite (back) side of the respective dielectric element 1016 which faces away from an individual's right ear. Again, for ease of illustration, FIG. 10B includes only specific reference labels of the first electrically conductive grid 101242, the second electrically conductive grid 101442, and the dielectric element 1016 of the audio transducer cell LC_{4,2}.

In FIG. 10A, the control system 1020L is configured to independently drive each audio transducer cell LC_{i,j} of the left earphone 1010L using respective control lines 1020L-C1 and 1020L-C2. In particular, the control lines 1020L-C1 comprise a first set of individual control lines that are coupled to respective ones of the first electrically conductive grids 1012_{i,j} of the audio transducer cells LC_{i,j}, and the control lines 1020L-C2 comprise a second set of individual control lines that are coupled to respective ones of the second electrically conductive grids 1014_{i,j} of the audio transducer cells LC_{i,j}. Similarly, in FIG. 10B, the control system 1020R is configured to independently drive each audio transducer cell RC_{i,j} of the right earphone 1010R using respective control lines 1020R-C1 and 1020R-C2. In particular, the control lines 1020R-C1 comprise a first set of individual control lines that are coupled to respective ones of the first electrically conductive grids 1012_{i,j} of the audio transducer cells RC_{i,j}, and the control lines 1020R-C2 comprise a second set of individual control lines that are coupled to respective ones of the second electrically conductive grids 1014_{i,j} of the audio transducer cells RC_{i,j}. In some embodiments, the insulating frames 1011L and 1011R of the respective left and right earphones 1010L and 1010R are structurally configured to route electrical lines/traces which connect the respective control lines 1020L-C1, 1020L-C2, 1020R-C1, and 1020R-C2 to respective ones of the first and second electrically conductive grids 1012_{i,j} and 1014_{i,j} of the audio transducer cells LC_{i,j} and RC_{i,j}.

In some embodiments, the control systems 1020L and 1020R are configured to receive or acquire audio signals, process the audio signals, and then amplify the audio signals to drive the respective audio transducer cells LC_{i,j} and RC_{i,j} of the left and right earphones 1010L and 1010R. In some embodiments, the control systems 1020L and 1020R comprises input and output audio interfaces that are configured to process analog or digital audio signals by decoding the audio signals into separate channels for driving the respective audio transducer cells LC_{i,j} and RC_{i,j} of the left and right earphones 1010L and 1010R, wherein the input and output audio interfaces implement, e.g., digital signal processing techniques to perform audio decoding (e.g., Dolby Atmos, DTS:X) to provide, e.g., 3D sound, and perform digital-to-analog conversion and signal amplification for each channel, to thereby generate output signals to individually drive respective audio transducer cells LC_{i,j} and RC_{i,j} of the left and right earphones 1010L and 1010R. Collectively, the control systems 1020L and 1020R comprise a control system that is configured to receive or acquire an audio signal, decode the audio signal into separate audio channels for driving the respective audio transducer cells of the first array and second array of audio transducer cells LC_{i,j} and RC_{i,j} of the left and right earphones 1010L and 1010R, generate voltages that are modulated in accordance with the separate audio channels, and apply the voltages to respective first and second electrically conductive elements 1012_{i,j} and 1014_{i,j} of the audio transducer cells of the first array and second array of audio transducers cells LC_{i,j} and RC_{i,j} to reproduce three-dimensional sound based on the audio signal.

In some embodiments, each transducer cell in the left and right arrays of audio transducer cells LC_{i,j} and RC_{i,j} is a separate audio channel in a DOLBY ATMOS or other 3D surround sound system configuration. A 3D audio system utilizes multiple audio channels to create the illusion of sound coming from various directions in 3D space by manipulating the volume, timing, and frequency of sound signals sent to different speakers, effectively mimicking how our cars naturally localize sound based on subtle differences in the audio reaching each car.

For example, the audio transducer cells LC_{i,j} of the left earphone 1010L are configured to provide 3D sound to the left car of the listener, while the audio transducer cells RC_{i,j} of the right earphone 1010R are configured to provide 3D sound to the right car of the listener. As schematically illustrated in FIGS. 10A and 10B, the individually addressable audio transducer cells RC_{i,j} of the right earphone 1010R are operatively arranged/configured in a mirror image of the individually addressable audio transducer cells LC_{i,j} of the left earphone 1010L.

In particular, in FIG. 10A, the array of audio transducer cells LC_{i,j} of the left earphone 1010L are indexed/numbered starting from a center cell LC_{1,1} to (i) a first circular row with cells LC_{2,1}-LC_{2,8} indexed/numbered in a counter clockwise sequence, (ii) a second circular row with cells LC_{3,1}-LC_{3,8} indexed/numbered in a counter clockwise sequence, and (ii) a third circular row with cells LC_{4,1}-LC_{4,8} indexed/numbered in a counter clockwise sequence. Moreover, in FIG. 10B, the array of audio transducer cells RC_{i,j} of the right earphone 1010R are indexed/numbered starting from a center cell RC_{1,1} to (i) a first circular row with cells RC_{2,1}-RC_{2,8} indexed/numbered in a clockwise sequence, (ii) a second circular row with cells RC_{3,1}-RC_{3,8} indexed/numbered in a clockwise sequence, and (ii) a third circular row with cells LC_{4,1}-LC_{4,8} indexed/numbered in a clockwise sequence. With this configuration, corresponding cells LC_{i,j} and RC_{i,j} of the left and right earphones 1010L and 1010R with the same index are disposed in the same/similar spatial location with respect to the left and right cars of an individual, to thereby facilitate the implementation of a 3D sound system configuration using earphones.

It is to be noted FIGS. 10A and 10B schematically illustrate an exemplary non-limiting embodiment of the audio transducer cells LC_{i,j} and RC_{i,j} of the left and right earphones 1010L and 1010R, and that the number, arrangement, size, and spacing of the audio transducer cells LC_{i,j} and RC_{i,j} of the left and right earphones 1010L and 1010R may be configured to achieve any desired 3D sound effect. Moreover, in some embodiments, the control systems 1020L and 1020R comprise a control system that is implemented in a separate control module/block which is disposed inline between an audio source (e.g., mobile phone) and the left and right earphones 1010L and 1010R.

For example, in some embodiments, for wired earphones, the control systems 1020L and 1020R can be implemented and housed in a control module that is serially connected in line with earphone wiring. In such embodiments, the control module can have an input port that is coupled to an audio source (e.g., mobile phone) via input wiring (to receive audio signals and DC power), and two output ports that are coupled to the respective left and right earphones 1010L and 1010R with a first wiring bus that includes the control lines 1020L-C1 and 1020L-C2 for the left earphone 1010L, and a second wiring bus that includes the control lines 1020R-C1 and 1020R-C2 for the right earphone 1010R. For wireless earphones, the control module can have an input that is coupled to an audio source (e.g., mobile phone) via input wiring (to receive audio signals and power), and a wireless transmitter system (e.g., Bluetooth) which wirelessly transmits control signals to wireless receivers of the left and right earphones 1010L and 1010R. The wireless transmitter may be embedded in any device including, but not limited to, a cell phone, a computer, a personal digital assistant, a television set, etc.

It is to be noted that in embodiments where the left and right earphones 1010L and 1010L are implemented as earbuds that fit within the outer ear canal, each array of audio transducer cells LC_{i,j} and RC_{i,j} as shown in FIGS. 10A and 10B can be constructed to have a diameter of approximately 12 millimeters to 15 millimeters. In embodiments where the left and right earphones 1010L and 1010L are implemented for use in canalphones, each array of audio transducer cells LC_{i,j} and RC_{i,j} can be constructed to have a diameter of approximately 8 millimeters to 13 millimeters. In embodiments where the left and right earphones 1010L and 1010L are implemented for use in “on car” or “over car” headsets, each array of audio transducer cells LC_{i,j} and RC_{i,j} can be constructed to have a diameter of approximately 25 millimeters to 60 millimeters. It is to be noted that smaller diameters than those cited are permissible.

It is to be appreciated that the exemplary earphone embodiments provide support for 3D surround sound formats including, but not limited to, Dolby Atmos, DTS:X (by DTS, Inc. a subsidiary of Xperi Holding Corporation), Auro-3D, Sony 360 Reality Audio, IMAX Enhanced (with DTS), THX Spatial Audio, MPEG Surround, SRS Labs Circle Surround, Apple Spatial Audio with Dolby Atmos, etc. As is known in the art, Dolby surround sound and Atmos configurations are denoted by a numerical code (e.g., 5.1.2 or 7.1.4), representing the following: (i) first number: traditional horizontal surround speakers (front, side, rear); (ii) second number: low-frequency effects (LFE) channels, usually a subwoofer; and (iii) third number: overhead or height speakers for 3D sound.

Some common configurations include, e.g., (i) basic configuration: 2.1: two speakers (left, right) and one subwoofer (not Atmos-enabled but can process virtualized Atmos effects), (ii) 5.1: five horizontal speakers (front left, center, front right, surround left, surround right) and one subwoofer (common baseline for home theaters). Dolby Atmos-enabled configurations include: (i) 5.1.2 which corresponds to five (5) horizontal speakers, one (1) subwoofer, and two (2) height channels; (ii) 5.1.4 which adds four height speakers for more precise overhead sound placement; (iii) 7.1.2 which includes seven (7) horizontal speakers (adds two rear surrounds to the 5.1 setup), one (1) subwoofer, and two (2) height channels; (iv) 7.1.4 which includes seven (7) horizontal speakers, one (1) subwoofer, and four (4) height speakers. Moreover, 3D sound systems that are commonly implemented in high-end home theaters include; (i) 9.1.2 or 9.1.4, which include nine (9) horizontal speakers (adding front-wide speakers), one (1)) subwoofer, and two (2) or four (4) height speakers for even greater coverage. Moreover, advanced configurations include: (i) 11.1.4 which includes eleven (11) horizontal speakers (with additional mid-layer surround channels), one (1) subwoofer, and four (4) height speakers, and custom cinema systems in which professional cinemas can use various speaker configurations with dozens of channels to create highly immersive soundscapes.

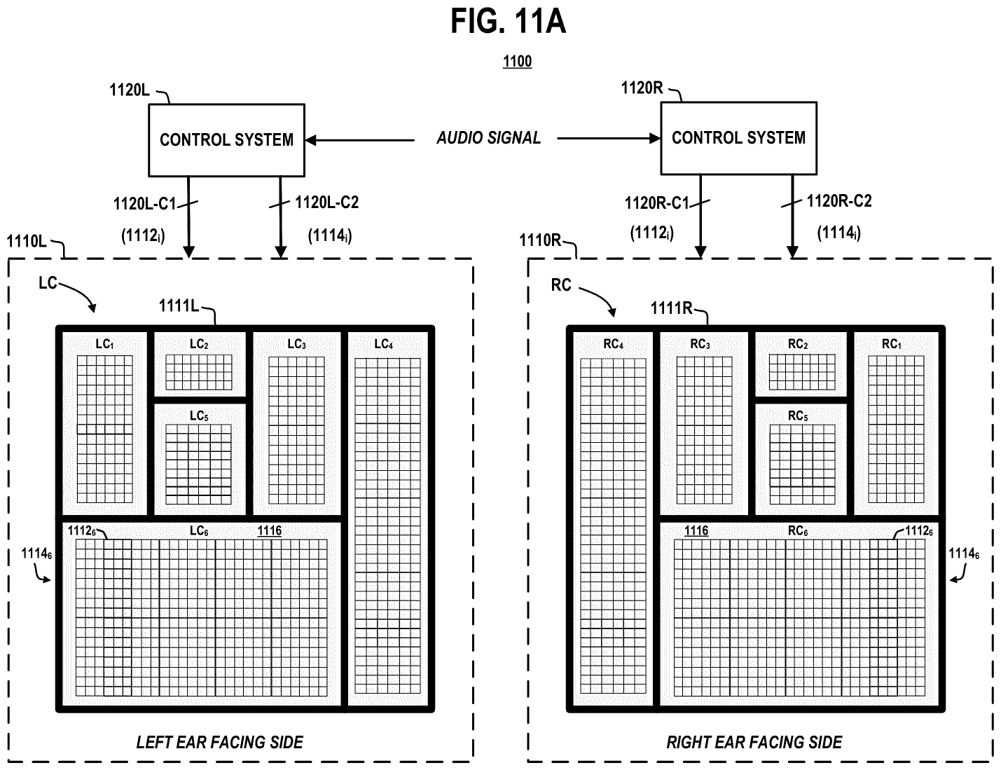

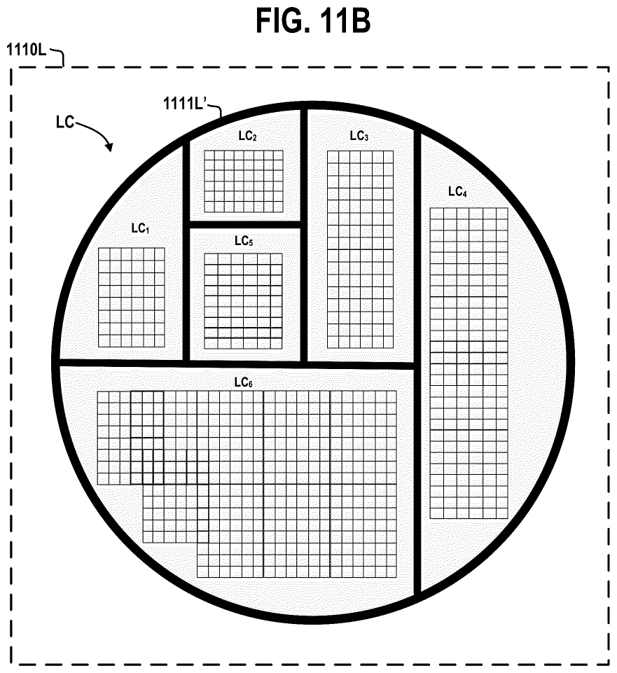

FIG. 11A schematically illustrates an audio sound reproduction apparatus which comprises earphones, according to an exemplary embodiment of the disclosure. FIG. 11A schematically illustrates an audio sound reproduction apparatus 1100 which comprises earphones that are configured to implement a DOLBY 7.2.2 3D sound configuration. The audio sound reproduction apparatus 1100 which comprises a left earphone 1110L and corresponding control system 1120L, and a right earphone 1110R and corresponding control system 1120R. The left earphone 1210L comprises an array of audio transducer cells LC including individually addressable transducer cells LC₁, LC₂, LC₃, LC₄, LC₅, LC₆ (generally denoted LCᵢ). Similarly, the right earphone 1110R comprises an array of audio transducer cells RC including individually addressable transducer cells RC₁, RC₂, RC₃, RC₄, RC₅, RC₆ (generally denoted RCᵢ). It is to be noted that the Dolby 7.2.2 configuration is comprised of a common center speaker (emulated by the transducer cells LC₄ and RC₄), a left front speaker (emulated by the transducer cell LC₃), a right front speaker (emulated by the transducer cell RC₃), a left side speaker (emulated by the transducer cell LC₅), and a right side speaker (emulated by transducer cell RC₅), a left rear speaker (emulated by transducer cell LC₁), and a right rear speaker (emulated by transducer cell RC₁), which comprise the “7” in Dolby 7.2.2). The two LFEs are emulated by the left subwoofer transducer cell LC₆ and the right subwoofer transducer cell RC₆ (which comprise the first “2” in Dolby 7.2.2), and two overhead speakers (left and right) emulated by the transducer cells LC₂ and RC₂ (which comprise the second 2 in Dolby 7.2.2).

The left earphone 1110L comprises an insulating frame 1111L which is structurally configured to mount and position the audio transducer cells LC₁, LC₂, LC₃, LC₄, LC₅, LC₆. Similarly, the right earphone 1110R comprises an insulating frame 1111R which is structurally configured to mount and position the audio transducer cells RC₁, RC₂, RC₃, RC₄, RC₅, RC₆. It is to be noted that in some embodiments, the audio transducer cells LCᵢ and RCᵢ of the left and right earphones 1110L and 1110R can be constructed, for example, using the same or similar materials and structural configurations as discussed above for exemplary quantum audio transducers 110, 130, and 140 as schematically illustrated in FIGS. 1A/1B, 1C, and 1D/1E. In this regard, each of the audio transducer cells audio transducer cells LCᵢ and RCᵢ of the left and right earphones 1110L and 1110R can be considered as a single instance of one of the quantum audio transducers 110, 130 or 140.

For purposes of illustration, in the exemplary embodiment shown in FIG. 11A, each of the audio transducer cells LC_{i, and} RCᵢ is shown as being implemented using the exemplary architecture of the quantum audio transducer 110 of FIGS. 1A and 1B, wherein each of the audio transducer cells LCᵢ and RCᵢ comprises a respective first electrically conductive grid (generally denoted 1112ᵢ), a second electrically conductive grid (generally denoted 1114ᵢ), and a dielectric element 1116 disposed between the first and second electrically conductive grids. In particular, FIG. 11A schematically illustrates one side (i.e. left ear facing side) of the array of audio transducer cells LC of the left earphone 1110L, which shows the first electrically conductive grid 1112ᵢ of each audio transducer cell LCᵢ disposed adjacent to a front side of the respective dielectric element 1116 of each audio transducer cell LCᵢ, while the second electrically conductive grid 1114ᵢ of each audio transducer cell LCᵢ is disposed adjacent to the opposite (back) side of the respective dielectric element 1116 which faces away from an individual's leaf ear. For ease of illustration, FIG. 11A includes only specific reference labels of the first electrically conductive grid 1112₆, the second electrically conductive grid 1114₆, and the dielectric element 1116 of the audio transducer cell LC₆.

Similarly, FIG. 11A schematically illustrates one side (i.e. right car facing side) of the array of audio transducer cells RC of the right earphone 1010R, which shows the first electrically conductive grid 1112ᵢ of each audio transducer cell RCᵢ disposed adjacent to a front side of the respective dielectric element 1116 of each audio transducer cell RCᵢ, while the second electrically conductive grid 1114ᵢ of each audio transducer cell RCᵢ is disposed adjacent to the opposite (back) side of the respective dielectric element 1116 which faces away from an individual's right ear. Again, for ease of illustration, FIG. 11A includes only specific reference labels of the first electrically conductive grid 1112₆, the second electrically conductive grid 1114₆, and the dielectric element 1016 of the audio transducer cell RC₆.

In some embodiments, each audio transducer cell LCᵢ and RC; in the left and right arrays of audio transducer cells LC and RC is a separate audio channel that emulates a 7.2.2 DOLBY 3D surround sound system configuration. In particular, in the left side array LC of audio transducer cells LCᵢ, the transducer cell LC₁ emulates a left rear speaker, the transducer cell LC₂ emulates a left overhead speaker, the transducer cell LC₃ emulates a left front speaker, the transducer cell LC₄ emulates a left center speaker, the transducer cell LC₅ emulates a left side speaker, and the transducer cell LC₆ emulates a left subwoofer speaker. Similarly, in the right-side array RC of audio transducer cells RCᵢ, the transducer cell RC₁ emulates a right rear speaker, the transducer cell RC₂ emulates a right overhead speaker, the transducer cell RC₃ emulates a right front speaker, the transducer cell RC₄ emulates a right center speaker, the transducer cell RC₅ emulates a right side speaker, and the transducer cell RC₆ emulates a right subwoofer speaker.

The audio transducer cells LCᵢ of the left earphone 1110L are configured to provide 3D sound to the left car of the listener, while the audio transducer cells RCᵢ of the right earphone 1110R are configured to provide 3D sound to the right car of the listener. As schematically illustrated in FIG. 11A, the individually addressable audio transducer cells RCᵢ of the right earphone 1110R are operatively arranged/configured in a mirror image of the individually addressable audio transducer cells LCᵢ of the left earphone 1110L. With this configuration, corresponding cells LCᵢ and RCᵢ of the left and right earphones 1110L and 1110R with the same index are disposed in the same/similar spatial location with respect to the left and right cars of an individual, to thereby facilitate the implementation of, e.g., a 3D Dolby Atmos sound system configuration using earphones.

In FIG. 11A, in some embodiments, the control system 1120L is configured to independently drive each audio transducer cell LCᵢ of the left earphone 1110L using respective control lines 1120L-C1 and 1120L-C2. In particular, the control lines 1120L-C1 comprise a first set of individual control lines that are coupled to respective ones of the first electrically conductive grids 1112ᵢ of the audio transducer cells LCᵢ, and the control lines 1120L-C2 comprise a second set of individual control lines that are coupled to respective ones of the second electrically conductive grids 1114ᵢ of the audio transducer cells LCᵢ. Similarly, the control system 1020R is configured to independently drive each audio transducer cell RCᵢ of the right earphone 1110R using respective control lines 1120R-C1 and 1120R-C2. In particular, the control lines 1120R-C1 comprise a first set of individual control lines that are coupled to respective ones of the first electrically conductive grids 1112ᵢ of the audio transducer cells RCᵢ, and the control lines 1120R-C2 comprise a second set of individual control lines that are coupled to respective ones of the second electrically conductive grids 1114ᵢ of the audio transducer cells RCᵢ. In some embodiments, the insulating frames 1111L and 1111R of the respective left and right earphones 1110L and 1110R are structurally configured to route electrical lines/traces which connect the respective control lines 1120L-C1, 1120L-C2, 1120R-C1, and 1120R-C2 to respective ones of the first and second electrically conductive grids 1112ᵢ and 1114ᵢ of the audio transducer cells LCᵢ and RCᵢ.

In some embodiments, the control systems 1120L and 1120R are configured to receive or acquire audio signals, process the audio signals, and then amplify the audio signals to drive the respective audio transducer cells LCᵢ and RCᵢ of the left and right earphones 1110L and 1110R. In some embodiments, the control systems 1120L and 1120R comprises input and output audio interfaces that are configured to process analog or digital audio signals by decoding the audio signals into separate channels for driving the respective audio transducer cells LCᵢ and RCᵢ of the left and right earphones 1110L and 1110R, wherein the input and output audio interfaces implement, e.g., digital signal processing techniques to perform audio decoding (e.g., Dolby Atmos, DTS:X) to provide, e.g., 3D sound effects, and perform digital-to-analog conversion and signal amplification for each channel, to thereby generate output signals to individually drive respective audio transducer cells LCᵢ and RCᵢ of the left and right earphones 1110L and 1110R.

Collectively, the control systems 1120L and 1120R comprise a control system that is configured to receive or acquire an audio signal, decode the audio signal into separate audio channels for driving the respective audio transducer cells LCᵢ and RCᵢ of the first array and second array of audio transducer cells LC and RC of the left and right earphones 1110L and 1110R, generate voltages that are modulated in accordance with the separate audio channels, and apply the voltages to respective first and second electrically conductive elements 1112ᵢ and 1114ᵢ of the audio transducer cells LCᵢ and RCᵢ of the first array and second array of audio transducers cells LC and RC to reproduce three-dimensional sound based on the audio signal. It is to be noted that, in some embodiments, the control systems 1120L and 1120R comprises a control system which is implemented in a separate control module/block that is disposed inline between an audio source (e.g., mobile phone) and the left and right earphones 1110L and 1110R using the same or similar configurations (for wired or wireless) as discussed above for the exemplary embodiment of FIGS. 10A and 10B.

Again, it is to be noted that in some embodiments, each audio transducer cell LCᵢ and RC; in the left and right arrays of audio transducer cells LC and RC is a separate audio channel in a Dolby Atmos or other 3D surround sound system configuration. As noted above, the 3D audio system utilizes multiple audio channels to create the illusion of sound coming from various directions in 3D space by manipulating the volume, timing, and frequency of sound signals sent to different transducer cells LCᵢ and RCᵢ (which emulate different spatially placed speakers) to thereby effectively mimic how human cars naturally localize sound based on subtle differences in the audio reaching each car.

FIG. 11A illustrates an exemplary embodiment in which an outer perimeter of the insulating frames 1111L and 1111R of the left and right audio transducer cell arrays LC and RC are rectangular-shaped. However, the insulating frames 1111L and 1111R can have other shapes as desired for a given implementation. For example, FIG. 11B illustrates an exemplary embodiment in which the left transducer cell array LC has an insulating frame 1111L′ which has a circular-shaped outer perimeter. While not shown in FIG. 11B, the insulating frame of the right transducer cell array RC would also have the same circular-shaped configuration.

It is to be noted that in embodiments where the left and right earphones 1110L and 1110L are implemented as earbuds that fit within the outer ear canal, each array of audio transducer cells LC and RC as shown in FIG. 11A or 11B can be constructed to have a diameter (or width) of approximately 12 millimeters to 15 millimeters. In embodiments where the left and right earphones 1110L and 1110L are implemented for use in canalphones, each array of audio transducer cells LC and RC can be constructed to have a diameter of approximately 8 millimeters to 13 millimeters. In embodiments where the left and right earphones 1110L and 1110L are implemented for use in “on ear” or “over ear” headsets, each array of audio transducer cells LC and RC can be constructed to have a diameter of approximately 25 millimeters to 60 millimeters.

FIG. 12 schematically illustrate an audio sound reproduction apparatus which comprises earphones, according to an exemplary embodiment of the disclosure. In particular, FIG. 12 illustrates an audio sound reproduction apparatus 1200 which comprises a left earphone 1210L and corresponding control system 1220L, and a right earphone 1210R and corresponding control system 1220R. The left earphone 1210L comprises a rectangular array of audio transducer cells, generally denoted LC_{i,j}, wherein the transducer cells are individually addressable by a first (row) index i (e.g., i=1, 2, 3, 4, 5, 6, 7, 8), and a second (column) index j (e.g., j=1, 2, 3, 4, 5, 6, 7, 8). Similarly, the right earphone 1210R comprises a rectangular array of audio transducer cells, generally denoted RC_{i,j}, wherein the transducer cells are individually addressable by a first (row) index i (e.g., i=1, 2, 3, 4, 5, 6, 7, 8) and a second (column) index j (e.g., j=1, 2, 3, 4, 5, 6, 7, 8).

The left earphone 1210L comprises an insulating frame 1211L which is structurally configured to mount and position the array of audio transducer cells LC_{i,j} in a rectangular array configuration. Similarly, the right earphone 1210R comprises an insulating frame 1211R which is structurally configured to mount and position the array of audio transducer cells RC_{i,j} in a rectangular array configuration. It is to be noted that in some embodiments, the array of audio transducer cells LC_{i,j} and RC_{i,j} of the left and right earphones 1210L and 1210R can be constructed, for example, using the same or similar materials and structural configurations as discussed above for exemplary quantum audio transducers 110, 130, and 140 as schematically illustrated in FIGS. 1A/1B, 1C, and 1D/1E. In this regard, each of the audio transducer cells LC_{i,j} and RC_{i,j} of the left and right earphones 1210L and 1210R can be considered as a single instance of one of the quantum audio transducers 110, 130 or 140.

The audio sound reproduction apparatus 1200 is similar in architecture and operation as the audio sound reproduction apparatus 1000 of FIGS. 10A and 10B, except that the audio sound reproduction apparatus 1200 implements left and right rectangular arrays of audio transducer cells LC_{i,j} and RC_{i,j} (in contrast to the circular/radial arrays shown in FIGS. 10A and 10B). For example, in the non-limiting exemplary embodiment of FIG. 12, the left side rectangular array of audio transducer cells LC_{i,j} comprises 64 individually addressable transducer cells (8×8 rectangular array) where the rows of transducer cells are numbered/indexed from top to bottom starting with a first row (i=1) and ending with an eighth row (i=8), and where the columns of transducer cells are numbered/indexed from right to left starting with a first column (j=1) and ending with an eighth column (j=8). Similarly, the right side rectangular array of audio transducer cells RC_{i,j} comprises 64 individually addressable transducer cells (8×8 rectangular array) where the rows of transducer cells are numbered/indexed from top to bottom starting with a first row (i=1) and ending with an eighth row (i=8), and where the columns of transducer cells are numbered/indexed from left to right starting with a first column (j=1) and ending with an eighth column (j=8).

In this array configuration, as with the exemplary array embodiments discussed above, the left and right side rectangular arrays of audio transducer cells LC_{i,j} and RC_{i,j} are mirror images of each other such that corresponding cells LC_{i,j} and RC_{i,j} of the left and right earphones 1210L and 1210R with the same index are disposed in the same/similar spatial location with respect to the left and right cars of an individual, to thereby facilitate the implementation of a 3D sound system configuration using earphones and achieve any desired 3D sound effect. While FIG. 12 illustrates an exemplary embodiment of earphones implemented with an 8×8 rectangular array of transducer cells, it is to be understood that the number, arrangement, size, and spacing of the audio transducer cells LC_{i,j} and RC_{i,j} of the left and right earphones 1210L and 1210R may be configured to achieve any desired 3D sound effect and desired audio surround sound resolution.

In FIG. 12, in some embodiments, the control system 1220L is configured to independently drive each audio transducer cell LC_{i,j} of the left earphone 1210L using respective control lines 1220L-C1 and 1220L-C2. In particular, the control lines 1220L-C1 comprise a first set of individual control lines that are coupled to respective ones of the first electrically conductive grids 1112_{i,j} of the audio transducer cells LC_{i,j}, and the control lines 1220L-C2 comprise a second set of individual control lines that are coupled to respective ones of the second electrically conductive grids 1214_{i,j} of the audio transducer cells LC_{i,j}. Similarly, the control system 1220R is configured to independently drive each audio transducer cell RC_{i,j} of the right earphone 1210R using respective control lines 1220R-C1 and 1220R-C2. In particular, the control lines 1220R-C1 comprise a first set of individual control lines that are coupled to respective ones of the first electrically conductive grids 1212_{i,j} of the audio transducer cells RC_{i,j}, and the control lines 1220R-C2 comprise a second set of individual control lines that are coupled to respective ones of the second electrically conductive grids 1214_{i,j} of the audio transducer cells RC_{i,j}. In some embodiments, the insulating frames 1211L and 1211R of the respective left and right earphones 1210L and 1210R are structurally configured to route electrical lines/traces which connect the respective control lines 1220L-C1, 1220L-C2, 1220R-C1, and 1220R-C2 to respective ones of the first and second electrically conductive grids 1212_{i,j} and 1214_{i,j} of the audio transducer cells LC_{i,j} and RC_{i,j}.

In some embodiments, the control systems 1220L and 1220R are configured to receive audio signals, process the audio signals, and then amplify the audio signals to drive the respective audio transducer cells LC_{i,j} and RC_{i,j} of the left and right earphones 1210L and 1210R using the same or similar techniques as discussed above to achieve a 3D surround sound effect, the details of which need not be repeated. Collectively, the control systems 1220L and 1220R comprise a control system that is configured to receive or acquire an audio signal, decode the audio signal into separate audio channels for driving the respective audio transducer cells of the first array and second array of audio transducer cells LC_{i,j} and RC_{i,j} of the left and right earphones 1210L and 1210R, generate voltages that are modulated in accordance with the separate audio channels, and apply the voltages to respective first and second electrically conductive elements 1212_{i,j} and 1214_{i,j} of the audio transducer cells of the first array and second array of audio transducers cells LC_{i,j} and RC_{i,j} to reproduce three-dimensional sound based on the audio signal. Moreover, in some embodiments, the control systems 1220L and 1220R are implemented in a separate control module/block, which is disposed inline between an audio source (e.g., mobile phone) and the left and right earphones 1210L and 1210R using the same or similar configurations (for wired or wireless) as discussed above for the exemplary embodiment of FIGS. 10A and 10B, the details of which need not be repeated.

It is to be understood that the exemplary embodiments shown in FIGS. 1A, 1B, 1C, 1D, 1E, 2, 3, 4, 5A, 5B, 6A, 6B, 6C, 7, 8, 9A, 9B, 10A, 10B, 11A, 11B, and 12 are presented for purposes illustrating various structural and operating characteristics of quantum audio transducers and quantum audio transducer arrays and associated control circuitry, and that other configurations of quantum audio transducers and quantum audio transducer arrays can be envisioned by one of ordinary skill in the art based on the teachings. For example, in some embodiments, components of a quantum audio transducer or portions of such components can be masked to alter the audio output dynamic range. In some embodiments, one or more different electrically conductive metal grid materials and/or dielectric materials can be utilized to provide one or more defined coverage angles. In some embodiments, one or more different electrically conductive grid materials and/or dielectric materials are utilized to provide outputs from different frequency ranges.

In some embodiments, one or more of the electrically conductive elements and and/or dielectric elements of an audio transducer are configured in one or more geometric shapes and so positioned or orientated to provide one or more defined audio output coverage angles, or to provide line array coverage.

In some embodiments, one or more of electrically conductive elements and/or dielectric elements of an audio transducer are segmented into one or more grids or patterns and modulated in accordance with reproduced audio signal.

In some embodiments, one or more of electrically conductive elements and/or dielectric elements of an audio transducer are segmented into more than one grid or pattern, with the at least one of the grid or patterns active and modulated in accordance with reproduced audio signal.

In some embodiments, one or more electrically conductive elements and/or dielectric elements of an audio transducer are segmented into more than one grid or pattern, with the at least one of the grid or patterns active and modulated in accordance with reproduced audio signal.

In some embodiments, one or more electrically conductive elements of an audio transducer are sprayed or otherwise deposited onto the surface of the dielectric element.

In some embodiments, the dielectric element of an audio transducer is sprayed or otherwise deposited onto the surface of one or more one of the electrically conductive elements of the audio transducer.

In some embodiments, the electrically conductive elements comprise conductive grids wherein a spacing between conductors on the electrically conductive grids is the same. In other embodiments, the spacing between conductors on the electrically conductive grids is different. In some embodiments, the spacing between conductors on each electrically conductive grid are uniform. In other embodiments, the spacing between conductors on each electrically conductive grid are different.

In some embodiments, one or more of the electrically conductive elements (e.g., conductive grids) of the audio transducer is heated to lower the work function of the electrically conductive element, and thereby increase an amount of electrons that are emitted from the electrically conductive grid.

In some embodiments, the electrically conductive elements (e.g., conductive grids) may be sprayed or deposited onto one side of an insulator or dielectric. In some embodiments the electrical grids may be sprayed or deposited onto both sides of an insulator or dielectric. In some embodiments the electrically conductive ultra-thin molecular coatings may be sprayed or deposited onto one or both sides of an insulator or dielectric.

In some embodiments the electrically conductive grids and intervening dielectrics are fabricated utilizing semiconductor metallization deposition technology and scaled down to the sub millimeter, micron, or nanometer level to accommodate low voltage operation.

In this regard, although exemplary embodiments of the present disclosure have been described herein with reference to the accompanying figures, it is to be understood that the illustrative embodiments discussed herein are not limited to those precise embodiments, and that various other changes and modifications may be made therein by one skilled in the art without departing from the scope of the appended claims.

What is claimed is:

1. An apparatus, comprising:
an audio transducer comprising:
a first electrically conductive element;
a second electrically conductive element; and
a dielectric element disposed between the first electrically conductive element and the second electrically conductive element; and
a control system configured to generate a voltage that is modulated in accordance with an audio signal, and apply the voltage to the audio transducer to cause an electric field to be generated between the first electrically conductive element and the second electrically conductive element, wherein the electric field causes acoustic sound pressure to be generated which reproduces sound corresponding to the audio signal.

2. The apparatus of claim 1, wherein the dielectric element comprises a polyimide film.

3. The apparatus of claim 1, wherein at least one of the first electrically conductive element and the second electrically conductive element comprises an electrically conductive grid.

4. The apparatus of claim 3, wherein the electrically conductive grid comprises a copper mesh.

5. The apparatus of claim 1, wherein at least one of the first electrically conductive element and the second electrically conductive element comprises at least one curve-shaped structure that partially contacts a surface of the dielectric element.

6. The apparatus of claim 1, wherein the dielectric element is perforated.

7. The apparatus of claim 1, wherein the first electrically conductive element and the second electrically conductive element are spaced apart from respective first and second surfaces of the dielectric element.

8. The apparatus of claim 1, wherein at least one of the first electrically conductive element and the second electrically conductive element comprises a magnetic material.

9. The apparatus of claim 1, wherein at least one of the first electrically conductive element and the second electrically conductive element comprises a metallic material.

10. The apparatus of claim 1, wherein at least one of the first electrically conductive element and the second electrically conductive element comprises a perforated conductive sheet.

11. The apparatus of claim 1, wherein the first electrically conductive element and the second electrically conductive element each comprise a planar element.

12. The apparatus of claim 1, wherein the first electrically conductive element and the second electrically conductive element each comprise a curved element.

13. The apparatus of claim 1, wherein the first electrically conductive element and the second electrically conductive element comprise concentric geometric shapes.

14. The apparatus of claim 13, wherein the concentric geometric shapes comprise one of concentric circular shapes, concentric hexagonal shapes, and concentric cylindrical shapes.

15. The apparatus of claim 1, wherein the control system is configured to increase a voltage range of the voltage that is applied to the audio transducer to increase a peak sound pressure level.

16. The apparatus of claim 1, wherein the control system is configured to increase a voltage range of the voltage that is applied to the audio transducer to increase a root mean square sound pressure level.

17. An apparatus, comprising:
a pair of earphones including a left earphone and right earphone;
the left earphone comprising a first array of audio transducer cells;
the right earphone comprising a second array of audio transducer cells; and
a control system configured to operate the pair of earphones;
wherein the audio transducer cells of the first array and second array of audio transducer cells each comprise:
a first electrically conductive element;
a second electrically conductive element; and
a dielectric element disposed between the first electrically conductive element and the second electrically conductive element; and
wherein the control system is configured to receive or acquire an audio signal, decode the audio signal into separate audio channels for driving the respective audio transducer cells of the first array and second array of audio transducer cells, generate voltages that are modulated in accordance with the separate audio channels, and apply the voltages to respective first and second electrically conductive elements of the audio transducer cells of the first array and second array of audio transducers cells to reproduce three-dimensional sound based on the audio signal.

18. The apparatus of claim 17, wherein the first and second electrically conductive elements of the audio transducer cells comprise electrically conductive grids.

19. The apparatus of claim 17, wherein the three-dimensional sound emulates a multi-speaker surround sound system.

20. The apparatus of claim 17, wherein the pair of earphones comprises one of earbuds, canalphones, and headphones.

21. The apparatus of claim 17, wherein the first array of audio transducer cells and the second array of audio transducer cells have mirror image structural layouts.

22. The apparatus of claim 17, wherein the first array of audio transducer cells and the second array of audio transducer cells each comprise a rectangular array of audio transducer cells.

23. The apparatus of claim 17, wherein the first array of audio transducer cells and the second array of audio transducer cells each comprise a circular and radial array of audio transducer cells.

24. The apparatus of claim 17, wherein the first array of audio transducer cells and the second array of audio transducer cells each comprise a rectangular array of audio transducer cells with different footprint area sizes of audio transducer cells within the arrays.

25. An apparatus, comprising:
an audio transducer comprising a first electrically conductive element and a second electrically conductive element disposed adjacent to each other; and
a control system configured to generate a voltage that is modulated in accordance with an audio signal, and apply the voltage to the audio transducer to cause an electric field to be generated between the first electrically conductive element and the second electrically conductive element, wherein the electric field causes acoustic sound pressure to be generated which reproduces sound corresponding to the audio signal.

26. The apparatus of claim 25, wherein at least one of the first electrically conductive element and the second electrically conductive element comprises an electrically conductive grid.

27. The apparatus of claim 26, wherein the electrically conductive grid comprises a copper mesh.

28. The apparatus of claim 25, wherein at least one of the first electrically conductive element and the second electrically conductive element comprises an electrically conductive surface.
